(19) United States
(12) Patent Application Publication
(10) Pub. No.: US 2026/0095715 A1
(43) Pub. Date: Apr. 2, 2026

(54) SYSTEMS AND METHODS FOR SYNCHRONIZED DELIVERY OF THREE DIMENSIONIONAL AUDIO THROUGH A PIEZOELECTRIC AUDIO SYSTEM INTEGRATED WITH A VISUAL DISPLAY

(71) Applicant: Adeia Guides Inc., San Jose, CA (US)

(72) Inventors: Ning Xu, Irvine, CA (US); Zhiyun Li, Kenmore, WA (US); Tao Chen, Palo Alto, CA (US)

(21) Appl. No.: 18/900,375

(22) Filed: Sep. 27, 2024

(51) Int. Cl. H04S 7/00; G06F 3/16

(52) U.S. Cl. CPC H04S 7/303; G06F 3/165; H04S 7/40; H04S 2400/11

(57) ABSTRACT

Systems and methods are described herein for utilizing piezoelectric transducer elements arranged in a planar array to generate audio that aligns with objects identified in corresponding visual content, wherein the generated audio enables the user to perceive audio depth and directionality. The disclosed techniques may automatically determine, using image analysis, a virtual region for an identified object corresponding to an audio component in 3D space in relation to a screen of the client device. The disclosed techniques may additionally define an audio wave field based on the virtual region for the identified object and the corresponding audio component and cause the piezoelectric transducer array to transmit an at least one audio wave to generate the audio wave field.

### BACKGROUND

This disclosure is related to systems and methods for audio wave field generation to provide an enhanced user experience described herein. In particular, the disclosure relates, in part, to delivering three-dimensional audio that aligns with visual content.

### SUMMARY

Technological advancements in audiovisual content delivery have enabled the creation of three-dimensional audio experiences that enable audio generation systems to deliver audio designed to be perceived as originating from distinct spatial positions within visual content. Such three-dimensional audio enhances an audio generation systems performance by providing, within the audio, a sense of depth and distance, immersing users in the content item's audio environment.

In some approaches, surround sound systems leverage specialized audio formats, strategically placed speakers, and audio processing technologies to deliver three-dimensional audio produced to accompany visual content. However, surround sound systems require a large quantity of precisely calibrated audio equipment mounted at particular positions in the user's environment, which increases the cost and complexity for implementation of these systems. Furthermore, these systems depend on content items that already include pre-produced surround sound audio, necessitating specialized audio formats, recording equipment, and encoding methods. Surround sound systems are also unable to dynamically adjust the spatial positions of audio based on the position of the user. Consequently, these solutions must rely on the generation of a broad sound field.

In other approaches, piezoelectric transducers are attached to a glass panel of a screen, which a small number (e.g., 2, 3) of the piezoelectric transducers vibrate to deliver spatial audio. These approaches may use a stereo pair of piezoelectric transducers to pan and position the audio across the horizontal axis in the plane of the scene. The resulting audio may also be further positioned along a vertical axis in the plane of the screen with the assistance of an additional center channel piezoelectric element.

However, these approaches are limited in their ability to produce accurate three-dimensional audio due to their inability to generate audio wave fields that enable the perception of depth. The delivery of three-dimensional audio that enables user perception of depth is significantly influenced by the number and configuration of the piezoelectric transducers used. Delivery of such audio requires the generation of a complex wavefront, which is not feasible with vibrations of a small number of piezoelectric transducer elements. Instead, a large number of piezoelectric transducer elements arranged in a planar array is beneficial to generate audio wave interference patterns that mimic the audio wave field of sound produced at a depth relative to a screen of a client device.

Additionally, with a small number of piezoelectric transducers, it becomes challenging to generate perceptible low-frequency audio (e.g., deep bass sounds). The reliance of such approaches on vibrating a glass screen additionally limits applications to OLED displays comprising thin layers and a large glass panel. These approaches are designed to be used in conjunction with surround sound system approaches, rather than as a replacement to such solutions. Consequently, these approaches also require pre-produced audio assets and large quantities of user equipment to deliver a three-dimensional audio experience.

Accordingly, to help address such problems, example systems and methods are provided herein, wherein the audiovisual (AV) system with a larger number of piezoelectric transducers (e.g., 10, 50, 100, or more piezoelectric transducers) automatically produces three-dimensional audio through visual analysis of content items described herein. In some embodiments, the AV system provides a large number of piezoelectric transducers in an array. In some embodiments, an AV system provides audio and visual content and additionally executes an AV application using one or more computing devices of the AV system.

In some approaches, the client device comprises a screen and a piezoelectric transducer array (e.g., an array of 10×10 piezoelectric transducer elements). In one example, the piezoelectric transducer array comprises a plurality of piezoelectric transducer elements arranged in an array (e.g., a planar array), wherein the array is arranged parallel to the screen. In some embodiments, the client device receives a content item including both a video asset and an audio asset. The AV application (e.g., when executing on control circuitry of the client device) identifies, in a time segment of the audio asset, an audio component attributable to an audio source. The AV application identifies an object depicted in a time segment of the video asset of the content item that corresponds to the audio source.

In some embodiments, the AV application performs image analysis of frames of the time segment of the video asset. Based at least in part on the AV application performing image analysis of frames of the time segment of the video asset, the disclosed AV application determines a virtual region for the identified object in 3D space in relation to the screen of the client device. The AV application defines an audio wave field based on the virtual region for the identified object and the audio component attributable to the audio source and causes the piezoelectric transducer array to transmit at least one audio wave associated with the audio wave field.

Such aspects enable the AV system to provide an immersive user experience by aligning audio sources with their corresponding visual counterparts while simultaneously controlling the depth and directionality of the sound to match the on-screen action. For example, a content item may be a news cast displaying two news anchors simultaneously on both the left side and the right side of the screen. In this example, the news anchor on the left side of the screen may be speaking. The AV system detects this position and causes the audio to sound as if it is emanating directly from the news anchor on the left side of the screen.

In some embodiments, the AV application determines the virtual region for the identified object in 3D space of the identified object in relation to the screen of the client device, which includes the AV application determining a 2D position in the plane of the screen and a depth of the identified object from the plane of the screen in a frame of the video asset. The AV application may determine, based on the identified 2D position and the identified depth, the virtual region of the identified object in 3D space in relation to the screen of the client device, wherein a distance of the virtual region from the screen of the client device is based on the AV application non-linearly scaling the identified depth. In some embodiments, the non-linear scaling of audio source depth enables the preservation of the audibility of audio components (e.g., dialogue), while also providing a three-dimensional audio experience.

For example, the AV application determines two characters conversing in a content item. The AV application may determine a first character to be two feet away from the plane of the screen of a client device and may non-linearly scale the distance to one foot away, whereas the second character that contributes to the dialogue that the AV system determined to be fifty feet away from the plane of the screen may be non-linearly scaled to ten feet away in order to ensure that the second character can be clearly heard. The AV system provides a depth component to the audio, delivering a three-dimensional auditory effect that complements the two-dimensional visual display (i.e., causing the audio emanating from the second character to sound farther away). By aligning the audio precisely with the visual elements, the system enables the realism of the viewing and listening experience.

The example systems and methods described herein help to overcome the deficiencies in existing solutions. The piezoelectric transducer array enables the delivery of three-dimensional audio through a single piece of equipment rather than a large quantity of mounted and calibrated equipment. The method described herein for the AV application defining and causing the transmitting of audio wave profiles provides for the conversion of traditional content items to three-dimensional audio assets. Such methods do not require preproduced content items with specialized audio formats as existing methods do. The method described herein for determining a virtual region based on user position allows for dynamic adjustment of the transmitted audio wave field as the user moves throughout a proximity of the device, enabling directed audio delivery and reducing the reliance on broad sound field generation. The large number of piezoelectric transducers in the array enables the generation of perceptible low frequency audio and complex audio wavefronts that allow the user to perceive audio sources as originating from a depth within the video asset. Additionally, the systems described herein are compatible with a variety of video display technology rather than solely OLED displays.

In some embodiments, determining, based at least in part on the image analysis, the virtual region of the identified object in 3D space in relation to the screen of the client device further comprises the AV system identifying, based at least in part on the image analysis, a subset of the identified object wherein the audio component attributable to the audio source originates from the subset of the identified object; and the AV system determining the virtual region of the identified object in 3D space based on the subset of the identified object. In some embodiments, the identified object is a person, and the subset of the identified object is a mouth of the person. For example, the media content may be a news cast with two news anchors displayed simultaneously on the left and right side of the screen. The news anchor on the left side may be speaking. The AV system identifies an object (e.g., the news anchor) as the source of the audio, defines the virtual region based on a subset of the object (e.g., the mouth of the news anchor), and transmits audio from the piezoelectric transducer array to emulate the audio component originating from the virtual region (e.g., defined by the area of the mouth).

In some embodiments, the AV system causing the piezoelectric transducer array arranged parallel to the screen to transmit the at least one audio wave associated with the audio wave field further comprises the AV system selecting, based on the virtual region, a subset of the plurality of piezoelectric transducer elements of the piezoelectric transducer array to transmit the at least one audio wave based on the virtual region. The AV system causes the transmitting of the at least one audio wave using only the subset of the plurality of piezoelectric transducer elements.

In some embodiments, the AV system identifies, in the time segment of the audio asset, an additional audio component attributable to an additional audio source. The AV system defines an additional audio wave field based on (a) an additional virtual region of an additional identified object in 3D space that corresponds to the additional audio source, and (b) the additional audio component. The AV system then causes the piezoelectric transducer array arranged parallel to the screen to transmit an additional at least one audio wave associated with the additional audio wave field.

In some embodiments, the AV system selects, based on the virtual region, a first subset of the plurality of piezoelectric transducer elements of the piezoelectric transducer array to transmit the at least one audio wave associated with the audio wave field. The AV system then causes the transmitting of the at least one audio wave associated with the audio wave field using only the first subset of the plurality of piezoelectric transducer elements. The AV system additionally selects, based on the additional virtual region, a second subset of the plurality of piezoelectric transducer elements of the piezoelectric transducer array to transmit the additional at least one audio wave associated with the additional audio wave field, wherein the first subset and the second subset do not comprise a common piezoelectric transducer element. The AV system then causes the transmitting of the additional at least one audio wave associated with the additional audio wave field using only the second subset of the plurality of piezoelectric transducer elements.

In some embodiments, the AV system comprises identifying that a user is in a proximity of the screen of the client device. The AV system determines a position of the user in relation to the screen of the client device. The AV system then determines the virtual region of the identified object in 3D space in relation to the screen of the client device based at least in part on the determined position of the user. In some embodiments, the AV system determines the position of the user in relation to the screen of the client device based on audio of the user detected through at least one piezoelectric transducer element of the piezoelectric transducer array functioning as an audio receiver.

In some embodiments, the AV system identifies, in the time segment of the audio asset, an additional audio component attributable to an additional audio source, wherein the additional audio source does not correspond to an object depicted in the time segment of the video asset of the content item. The AV system assigns a default virtual region in 3D space in relation to the screen of the client device to the additional audio and generates an additional audio wave field based on (a) the default virtual region of the additional audio source, and (b) the additional audio component. The AV system then causes the piezoelectric transducer array arranged parallel to the screen to transmit an at least one audio wave associated with the additional audio wave field.

In some embodiments, the AV system determines, based on the image analysis, a vector that represents a direction of the audio component. The AV system generates the audio wave field based on the vector and the virtual region of the identified object. In some embodiments, the AV system identifies an additional object depicted in the time segment of the video asset of the content item, wherein the determined vector originates in the object and points in the direction of the additional object. In one example, the object is an interviewer, and the additional object is the interviewee that the interviewer is currently addressing.

### BRIEF DESCRIPTION OF DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 is a schematic example of defining and causing the transmitting of an audio wave field based on the virtual region for an identified object and an audio component attributable to an audio source, in accordance with embodiments of the disclosure.

FIG. 2 is a schematic example of a non-linearly scaling of depth of multiple audio sources, in accordance with embodiments of the disclosure.

FIG. 3 is a schematic example of identifying a subset of an identified object associated with an audio component, in accordance with embodiments of the disclosure.

FIG. 4 is a schematic example of determining a virtual region of an identified object in 3D space based at least in part on a determined position of a user, in accordance with embodiments of the disclosure.

FIG. 5 is a schematic example of assigning a default virtual region in 3D space to an additional audio component, which does not correspond to an object depicted on the screen, in accordance with embodiments of the disclosure.

FIG. 6 is a schematic example of causing the transmitting of an audio wave field based on a vector that represents a direction of an audio component, in accordance with embodiments of the disclosure.

FIG. 7 is a schematic example of direct recording and playback of three-dimensional audio with a piezoelectric transducer array, in accordance with embodiments of the disclosure.

FIG. 8 is an illustrative example of an array of piezoelectric transducers arranged parallel to a screen, in accordance with embodiments of the disclosure.

FIG. 9 shows a sequence diagram for causing the transmitting of an audio wave field based on a virtual region for an identified object and an audio component, in accordance with some embodiments of this disclosure.

FIG. 10 shows illustrative devices and systems for causing a piezoelectric transducer array to transmit at least one audio wave field, in accordance with some embodiments of this disclosure.

FIG. 11 shows illustrative devices and systems for causing a piezoelectric transducer array to transmit at least one audio wave field, in accordance with some embodiments of this disclosure.

FIG. 12 is a flowchart of a detailed illustrative process for causing a piezoelectric transducer array to transmit at least one audio wave field, in accordance with some embodiments of this disclosure.

FIG. 13 is a flowchart of a detailed illustrative process for determining a virtual region of an identified object in 3D space based at least in part on a determined position of a user, in accordance with some embodiments of this disclosure.

FIG. 14 is a flowchart of a detailed illustrative process for causing a piezoelectric transducer array to transmit an audio wave field associated with an additional audio component, in accordance with some embodiments of this disclosure.

### DETAILED DESCRIPTION

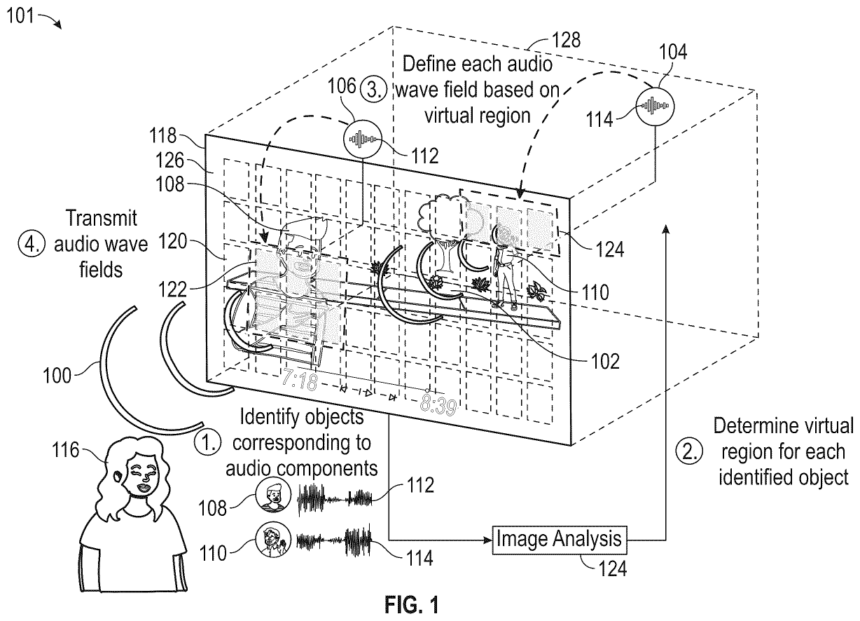

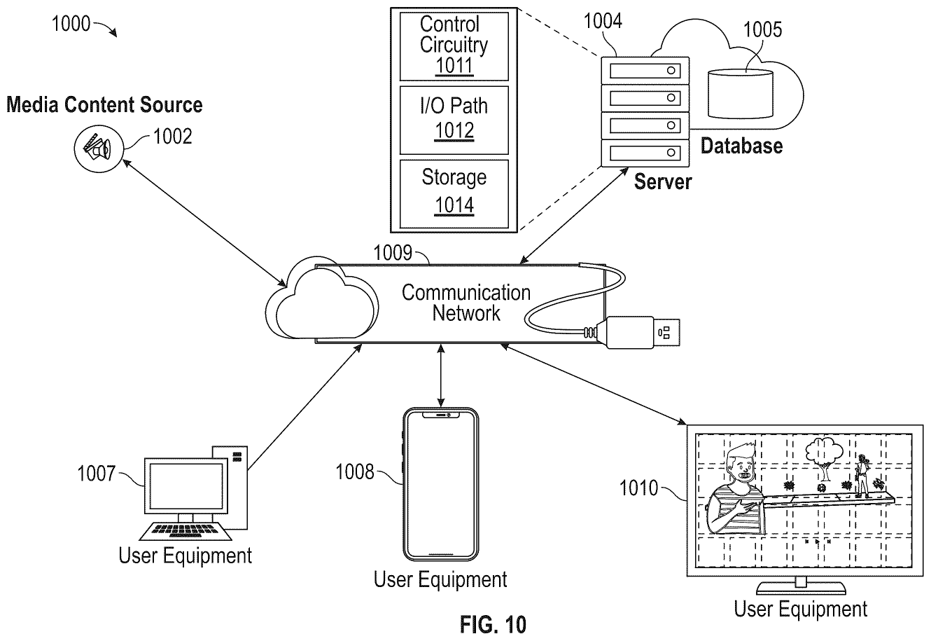

FIG. 1 shows an illustrative system 101 for defining and causing a transmittal of audio wave fields based on a virtual region determined for identified objects corresponding to audio components, in accordance with embodiments of the disclosure. In some embodiments, an audiovisual (AV) system 101 (referred to herein as “the AV system”) comprises or corresponds to a client device 118, a plurality of piezoelectric transducers 120, or any other suitable platform, or any combination thereof. The system may comprise or correspond to an AV application, consisting of instructions stored in a non-transitory memory that when executed causes certain effects. The AV application may be executed at least in part on the client device 118 and/or at one or more remote servers (e.g., server 1004 of FIG. 10 and/or media content source 1002 of FIG. 10). The AV system may be distributed across any of one or more other suitable computing devices, in communication over any suitable number and/or types of networks (e.g., the Internet). The AV application may be configured to perform the functionalities (or any suitable portion of the functionalities) described herein. In some embodiments, the AV application and/or the AV system is a stand-alone application, or is incorporated as part of any suitable application or system, e.g., a content creation and/or content editing application; a web browsing application; a social media application; a content provider application; a 2D application; an extended reality (XR) application; a supplemental content provider; a content acquisition, recognition and/or processing application; a machine learning model or AI system; or any other suitable application or system; or any combination thereof. The AV application and/or AV system may comprise or employ any suitable number of displays; sensors or devices such as those described in FIGS. 1-14; or any other suitable software and/or hardware components; or any combination thereof.

In some embodiments, the AV application may be installed at or otherwise provided to a particular computing device, may be provided via an API, or may be provided as an add-on application to another platform or application. In some embodiments, software tools (e.g., one or more software development kits, or SDKs) may be provided to any suitable party, to enable the party to implement the functionalities described herein.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment.

Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

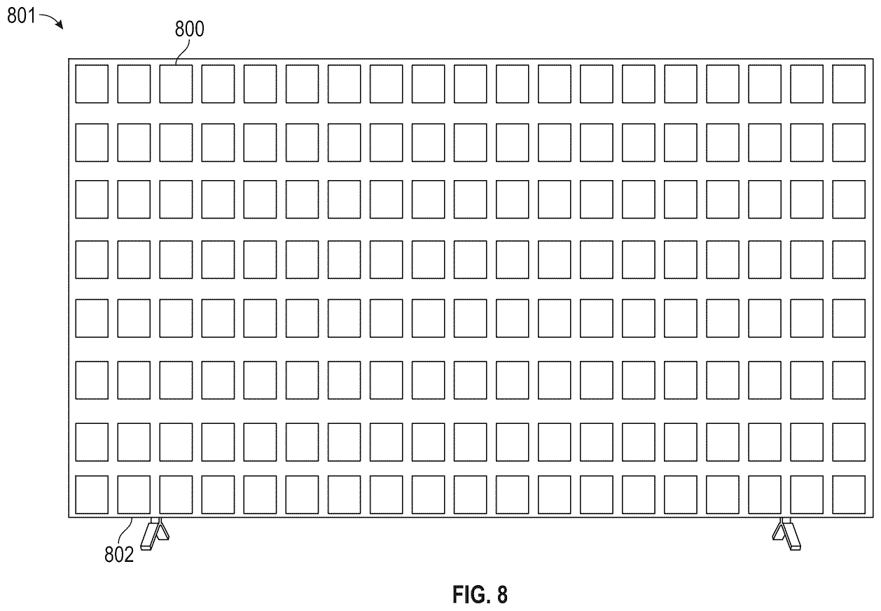

As shown in FIG. 1, the AV application may enable content to be received at client device 118. In one example, client device 118 is a smart television. In some embodiments, client device 118 comprises a piezoelectric transducer array (e.g., piezoelectric transducer array 800 of FIG. 8) consisting of a planar array of piezoelectric elements (e.g., 2×2 planar array) wherein the plane of the planar piezoelectric transducer array is arranged parallel to the plane of the screen (e.g., screen 802 of FIG. 8). In some embodiments, piezoelectric transducer array may be arranged in a number of various configurations, as described in FIG. 8. In another example, client device 118 comprises or corresponds to a mobile device, for example, a smartphone or tablet. In another example, computing device 118 comprises or corresponds to a laptop computer, a personal computer, a desktop computer, a smart watch or a wearable device, smart glasses, a stereoscopic display, a wearable camera, XR glasses, XR goggles, a near-eye display device, or any other suitable user equipment or computing device, or any combination thereof.

Piezoelectric transducers, e.g., flexural mode transducers, ultrasonic transducers, thickness mode transducers, piezocomposite transducers, micro-electro-mechanical systems (MEMS) transducers, are devices that utilize the piezoelectric effect to interconvert mechanical stress/deformation and electrical signals. Piezoelectric transducers may function as transmitters, producing precise vibrations capable of generating perceptible audio in response to an applied electric field. Piezoelectric transducers may also function as receivers, changing in voltage in response to mechanical vibrations. Piezoelectric transducers may alternate between the two functions based on receiving an indication to switch operational modes from the AV application.

In some embodiments, each piezoelectric transducer element in the piezoelectric transducer array (e.g., piezoelectric transducer array 800 of FIG. 8) is connected to a corresponding driver circuit that delivers specific waveforms to the piezoelectric transducer elements. In one example, the driver circuit of a piezoelectric transducer element may include filtering, amplification, or feedback circuits that condition the signal received from the piezoelectric transducer element such that it is suitable for further processing (e.g., audio signal received by a piezoelectric transducer element is low pass filtered to remove noise prior to being used to identify the location of a user). In another example, the AV application may implement pulse width modulation (PWM) techniques to control the output audio wave intensity of a piezoelectric transducer element.

In some embodiments, the piezoelectric transducer array is connected to and managed by a separate control unit, e.g., a microcontroller unit (MCU), digital signal processor (DSP), and/or field-programmable gate array (FPGA), that is controlled by the AV application. For example, the separate control unit (e.g., a FPGA) may implement a matrix control scheme where each piezoelectric transducer element or subsets of the piezoelectric transducer array may correspond to a single address. In another example, the AV application and/or separate control unit implements advanced control algorithms such as beamforming, adaptive signal processing, and spatial filtering to enable the piezoelectric transducer array to precisely deliver complex wavefronts.

In some embodiments, the AV system utilizes an array of piezoelectric transducers that is embedded within computing device 118 and/or attached in any configuration parallel to the screen of the computing device 118 (as described in FIG. 8). In some embodiments, the screen of the computing device 118 comprises or corresponds to any type of display technology, e.g., liquid crystal display (LCD), light emitting diode (LED), organic LED (OLED), plasma display, quantum dot LED (QLED). The piezoelectric transducer elements may be directly adhered to the screen of the computing device 118, embedded in a separate composite structure, or mounted to a rigid structure. The piezoelectric transducer array may additionally rely on wire bonding to connect individual piezoelectric transducer elements with a corresponding control unit (e.g., a separate control unit) and physically separate the individual elements. In one example, the AV application simultaneously controls the screen of the computing device 118 (e.g., an OLED display depicting the visual asset) and the piezoelectric transducer array (e.g., via a separate control unit).

In some embodiments, the AV application provides a user interface for interfacing with a content item (e.g., videos, audio, XR content that may be streamed to client device 118 from one or more servers). The AV application may communicate with remote servers (e.g., server 1004 of FIG. 10) to retrieve content the content item (e.g., content item 126). In some embodiments, the content item comprises a video asset and an audio asset.

In some embodiments, the AV application receives a content item from remote servers (e.g., server 1004 of FIG. 10). In one example, the content item depicts a scene in which multiple objects generate audio, e.g., the content item depicts characters 108 and 110 are conversing. Character 108 is a first object 108 that corresponds to a first audio source 112 and character 110 is a second object 110 that corresponds to a second audio source 114). Each of these objects are in a particular position on the plane of the two-dimensional display of the content item 126 and a depth into the three-dimensional (3D) (e.g., 3D-space 128) that comprises a virtual representation of the content item 126.

In some embodiments, the AV application is configured to identify an audio component (e.g., audio component 112, audio component 114) attributable to an audio source in the audio asset. In one example, the AV application may receive an audio asset comprising separate audio streams for each audio source via an AV delivery protocol, e.g., HTTP Live Streaming (HLS), Real-Time Streaming Protocol (RTSP), dynamic adaptive streaming over HTTP (DASH). The AV application may identify a particular audio file as a particular audio component based on metadata associated with the particular audio file. In another example, the AV application may receive an audio asset comprising a single mixed audio file that combines all of the audio components attributable to an audio source. In this example, the AV application conducts audio analysis to decompose the audio file into audio components corresponding to each audio source.

In some embodiments, the AV application conducts audio analysis without prior knowledge of the audio sources, employing one or more of the following: blind source separation techniques, e.g., non-negative matrix factorization or independent component analysis; model-based separation techniques, e.g., deep learning models, neural networks, spectral models; or time-frequency analyses, e.g., short-time Fourier transform, time-frequency masking, or spectrogram analysis. In embodiments where the AV application does not have prior knowledge of the audio sources, the AV application attributes the identified audio component to an audio source based on features of the audio component (e.g., frequency, power, time position) ascertained during the audio analysis. The AV application may reference metadata associated with the content item to attribute audio components to audio sources.

The AV application may also conduct audio analysis with prior knowledge of the audio sources and their corresponding properties (e.g., expected frequency, power, time position), employing one or more of the following: model-based separation techniques, e.g., deep learning models, neural networks, spectral models; or time-frequency analyses, e.g., short-time Fourier transform, time-frequency masking, or spectrogram analysis.

In some embodiments, AV application identifies a first object and a second object in the time segment of the video asset 126, for example, by referencing metadata associated with the content item. In some embodiments, the AV application is configured to employ any suitable computer implemented technique (e.g., one or more machine learning models) to perform image analysis 124 of video asset 126 to identify one or more objects corresponding to an audio component attributable to an audio source. In some embodiments, image analysis 124 identifies a first object 108 corresponding to the first audio component 112 and a second object 110 corresponding to the second audio component 114. In some embodiments, the first object 108 corresponding to the first audio component 112 and a second object 110 corresponding to the second audio component 114 are currently displayed in the video asset 126 to a user 116.

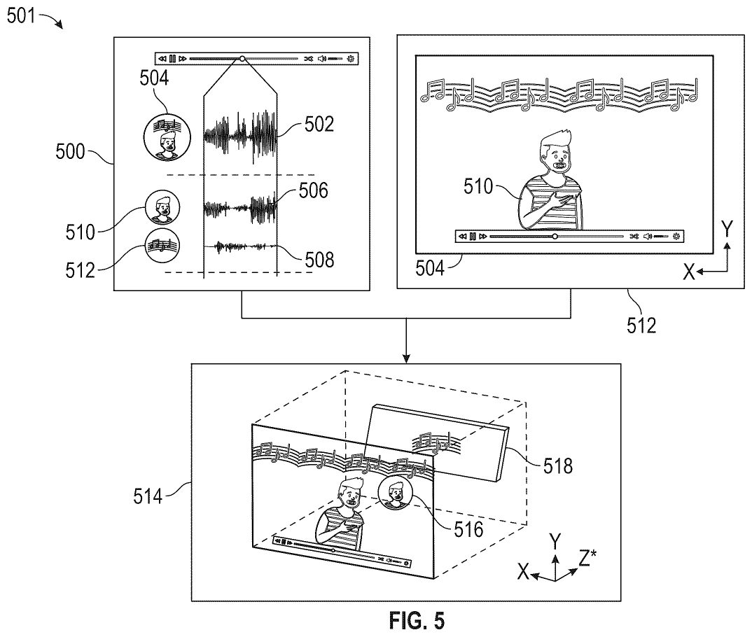

In other embodiments, the image analysis 124 determines that no object attributable to the audio source is present in the video asset. In one example, the AV application may identify an audio component is not attributable to an object in any frames of the video asset (e.g., audio component 508 corresponding to background music 512 of FIG. 5) and define an audio wave field based on a default virtual region. In another example, the AV application may identify an object corresponding to the audio source in future frames of the content item 126, that may not yet be displayed in the current frame of the content item. In this example, the AV application may define an audio wave field based on a default virtual region, wherein the default virtual region is based at least in part on image analysis of the identified object in future frames of the content item 126.

In some embodiments, based at least in part on image analysis 124, a virtual region 104 and 106 for the identified objects 108 and 110 are determined by the AV application, in 3D space 128 in relation to the screen of the client device 118. For example, image analysis 124 of AV application may determine the first object 108 is displayed as closer to the screen of client device 118 and the second object 110 is determined to be 10 feet away from the first object 108, as depicted in visual asset 126. Based at least in part on the image analysis 124, the AV application determines a first virtual region 106 for the first identified object 108 in 3D space 128 and a second virtual region 104 for the second identified object 110 is determined in 3D space 128. For example, the AV application may non-linearly scale the first virtual region 106 and the second virtual region 104 in 3D space 128 such that the first virtual region 106 remains at the identified depth and the second virtual region 104 is shifted closer in relation to the screen (e.g., perceived as louder) such that the second virtual region 104 is located 5 feet away from the first virtual region 106.

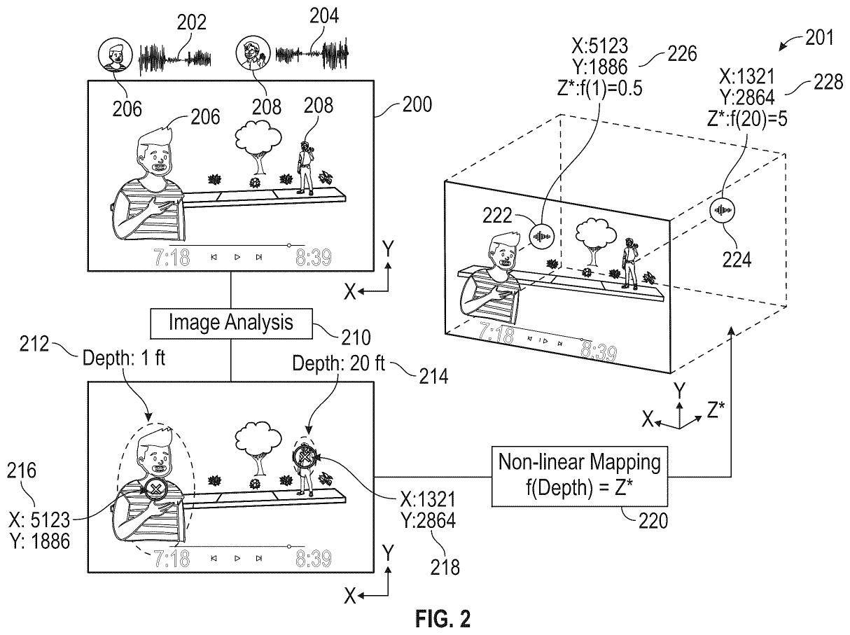

The virtual region (e.g., virtual region 104 or 106) may consist of, a point, line, area, plane, volume, or any geometric entity, or any combination thereof. For example, a virtual region approximates a sphere with a radius of 50 pixels positioned at the coordinate position (1321 pixels, 2864 pixels, 200 pixels), e.g., in accordance with the coordinate system (X, Y, Z*) depicted in FIG. 2. In another example, the virtual region may approximate a plane with normal vector <0,0,1>, with all points within the plane located 10 feet away from the plane of the screen 118. In another example, the screen 118 corresponds to a display that is 1280×720 pixels. A virtual region is determined to be a rectangle with a first corner at (200, 150, 50) and a second corner at (400, 600, 50). The virtual region may be positioned at any position, in the plane of the screen 118, in front of the plane of the screen 118 (i.e., positioned between the screen 118 and the user 116), or behind the plane of the screen 118 (i.e., positioned at a greater distance away from the user 116 than the screen 118). In some examples, the definition of the virtual region is permanent throughout the duration of the content item. In other examples, the virtual region is dynamically defined and changes in definition throughout duration of the content item.

In some embodiments, the AV application scales the virtual region (e.g., virtual region 104 and 106) in relation to the screen of a client device (e.g., client device 118) in 3D space behind the screen, as shown in FIG. 1. In some embodiments, the AV application scales the virtual region in relation to the screen of the client device in 3D space in front of the screen and/or in plane with the screen of the client device.

In some embodiments, based on the virtual regions 104 and 106 for the identified objects 110 and 108 respectively, the AV application defines an audio wave field 100 and 102. In one example, the AV application defines an audio wave field based on an approximation of the wave propagation of the audio component originating from a point source at a point in the virtual region (e.g., the centroid of the virtual region). In this example, the audio wave field is comprised of concentric spherical wavefronts of constant phase centered around the source. In another example, the AV application defines an audio wave field based on an approximation of the wave propagation of the audio component originating from a distributed source spread over the virtual region. The AV application may also define an audio wave field (e.g., audio wave field 100 or 102) based on an approximation of the wave propagation of the audio component originating from a directional source, wherein audio is emitted at higher amplitudes in certain directions. In these embodiments, the AV application models the effects of attenuation (e.g., a decrease in amplitude with distance consistent with the inverse square law) and optionally the effects of environmental factors (e.g., identified objects in the visual asset that reflect, refract, or absorb audio waves and consequently affect audio wave propagation behavior).

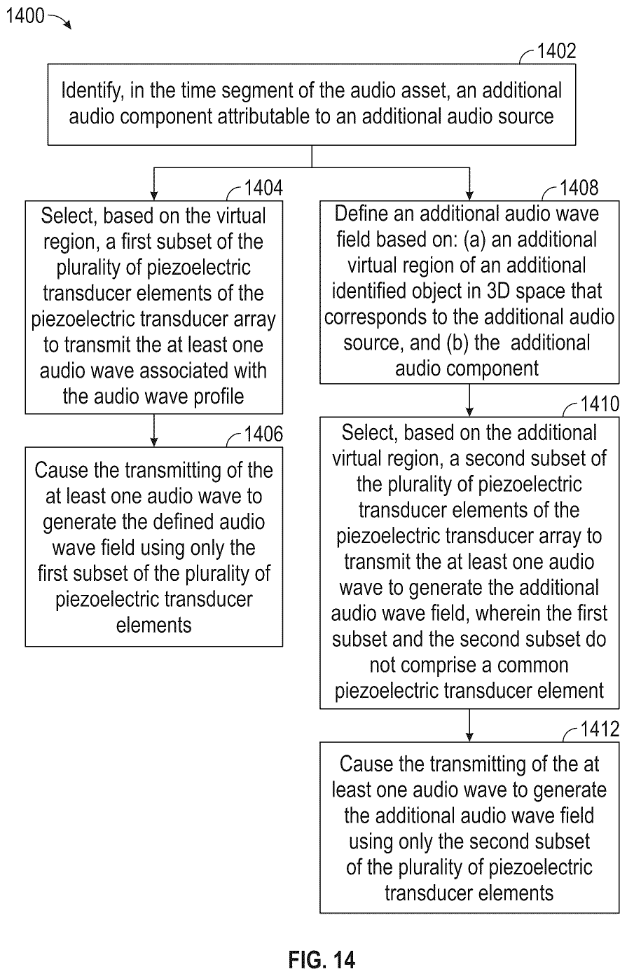

In some embodiments, the AV application causes the piezoelectric transducer array 120 to transmit audio waves to generate audio wave field 100 and 102. For example, the AV application may cause the transmitting of the audio wave fields (e.g., audio wave field 100 and field 102) by decomposing the audio wave field into multiple audio waves In one example, the AV application selects a subset of the elements of the piezoelectric transducer array 120 (e.g., subset 122 corresponding to audio wave field 100, subset 124 corresponding to audio wave field 102) to transmit such audio waves for each audio wave field, such that each piezoelectric transducer element generates audio waves for only one audio wave field at a time, e.g., as shown in FIG. 14. and causing each piezoelectric transducer element to generate an audio wave such that the interference pattern of the audio waves generates the desired audio wave field (e.g., via the Huygens Fresnel principle). The AV application may send multi-channel audio to the piezoelectric transducer array 102 in order to precisely control the audio waves generated by each piezoelectric transducer element.

In another example, the AV application mixes multiple audio waves corresponding to multiple audio wave fields (e.g., audio wave field 100 and 102) and causes the piezoelectric transducer elements to transmit mixed audio waves (e.g., comprising components of audio wave field 100 and 102). In this example, the AV application may cause each of the piezoelectric transducers of the piezoelectric transducer array 120 to transmit an audio wave (e.g., a mixed audio wave) to generate the one or more defined audio wave fields.

In some embodiments, the AV application causes the simultaneous transmitting of one or more audio wave fields (e.g., audio wave fields 100 and 102) through the piezoelectric transducer array 120 and the corresponding content item at the screen of the client device (e.g., synchronizing audio components and video components corresponding to the same time instance of the content item). In some embodiments, the AV application analyzes for one or more audio wave fields in real time and/or before transmission of the one or more audio wave fields and corresponding content item.

FIG. 2 is a schematic example 201 of a non-linearly scaling of depth of multiple audio sources, in accordance with embodiments of the disclosure. For example, FIG. 2 in some embodiments is implemented by AV system 101 of FIG. 1. In some embodiments, the AV application defines the virtual region (e.g., virtual region 222 or 224) based at least in part on image analysis 210 that determines a 2D position of the identified object (e.g., identified object 206 or 208) in the plane (e.g., 2D position 216 or 218) and a depth (e.g., depth 212 or 214) of the identified object in a frame of the video asset 200. The image analysis 210 may include object detection and tracking techniques (e.g., convolutional neural networks, Haar cascades) as well as monocular depth estimation techniques (e.g., convolutional neural networks, triangulation, depth from defocus, object size-based estimation, texture gradient analysis, vanishing point analysis). The image analysis 210 may also include techniques that analyze multiple frames of the video asset (e.g., depth from motion, convolutional neural networks).

In some embodiments, the identified depth (e.g., depth 212 or 214) estimates the depth of the identified object perceived by a user viewing the frame of the content item 200. The depth may be in units of distance (e.g., feet, meters), any other unit of measurement (e.g., pixels) or may be a unitless quantity. In some examples, the depth is calculated orthogonal to the plane of the screen. In other examples, the depth is calculated at an angle from the vector orthogonal to the plane of the screen.

In some embodiments, the AV application non-linearly scales the identified depth (e.g., depth 212 or 214) to a new non-linearly scaled depth (e.g., non-linearly scaled depth 226 or 228). The non-linear scaling 220 may be any function of the identified depth that does not scale all identified depths by the same amount. In some examples, the non-linear scaling 220 scales a wide range of depths (e.g., zero to infinity) to a smaller range of finite depths (e.g., zero to ten). The AV application may use a non-linear scaling 220 function to map the depth from 0 to infinity to a range of [D1, D2] range, where D1 is the minimum depth and D2 is the maximum depth. In some examples, the non-linear scaling function 220 may be an exponential decay function (e.g., f(x)=D1+(D2−D1)*(1-exp(−x)). In one example, the non-linear scaling function 220 may include D1 as zero and D2 as 1, wherein the scaling function is f(x)=1−e^{-x}. For example, a first speaker is identified to correspond to a depth of 1 meter while a second speaker is identified to correspond to a depth of 10 meters. The first speaker's identified depth is scaled by the non-linear scaling function 220 to be a depth of 0.632 meters while the second speaker's identified depth is scaled by the same non-linear scaling function 220 to be a depth of 1.0.

In such embodiments, the AV application non-linearly scales the identified depth such that the defined audio wave field enables all audio components (e.g., audio component 202 and 204) to be perceived by a user at their corresponding non-linearly scaled depths (e.g., non-linearly scaled depth 226 corresponding to audio component 202, non-linearly scaled depth 228 corresponding to audio component 204). In one example, image analysis 210 identifies audio component 202 to be at a depth 212 of 1 foot and similarly identifies audio component 204 to be at a depth 214 of 20 feet. In order to ensure that the user can hear both audio components, the AV application scales audio component 202 to a non-linearly scaled depth 226 of 0.5 feet, and similarly scales audio component 204 to a non-linearly scaled depth 228 of 5 feet.

In some embodiments, the AV application determines the virtual region (e.g., virtual region 222 or 224) based at least in part on the non-linearly scaled depth (e.g., identified depth 226 or 228) by placing the virtual region at a distance away from the identified 2D position (e.g., 2D position 216 or 218) in the plane of the screen, wherein the distance away from the identified 2D position is the non-linearly scaled depth. The non-linearly scaled depth may be in any direction (e.g., towards the user, away from the user, orthogonal to the plane of the screen, a non-zero angle from the normal of the plane of the screen). It should be understood that all features and aspects described herein are examples and may equally be applicable to negative depths. For example, the content may be a virtual reality (VR) content wherein the source may be in front of the screen in appearance or perception.

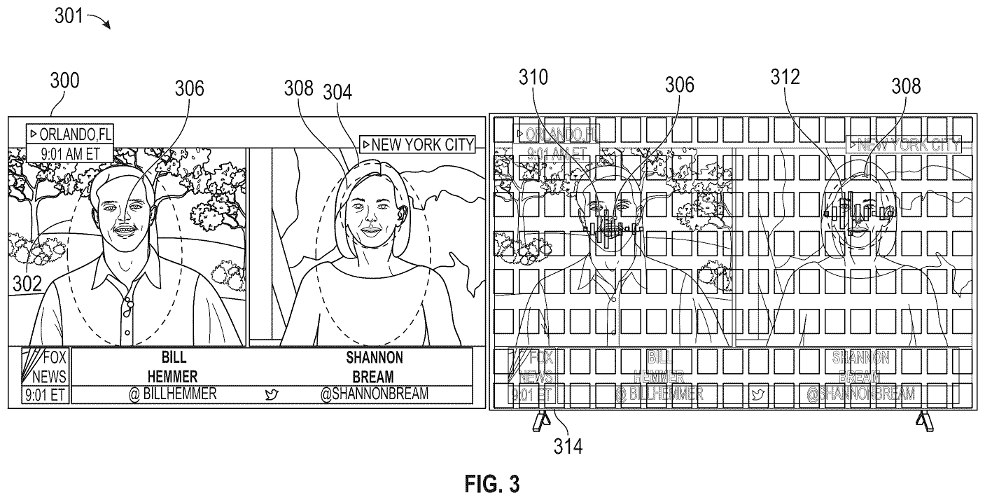

FIG. 3 is a schematic example 301 of identifying a subset of an identified object associated with an audio component, in accordance with embodiments of the disclosure. FIG. 3, in some embodiments, is implemented by system 101 of FIG. 1.

In some embodiments, the AV application determines, based at least in part on the image analysis of the visual asset 300, a subset of the identified object (e.g., a mouth 306 of news anchor 302, a head 308 of a news anchor 304), wherein the audio component (e.g., audio component 310 or 312) is determined to originate from the subset of the identified object. For example, an identified object is a news anchor 302 on a news broadcast 300 and the AV application determines, based on image analysis of the news broadcast 300, a subset that corresponds to a mouth 306 of the news anchor 302. In another example, an identified object is a news anchor 304 and the AV application determines, based on image analysis of the news broadcast 300, a subset that corresponds to a head 308 of a news anchor 304.

In some embodiments, the AV application determines the virtual region of the identified object (e.g., news anchor 302 or 304) in 3D space based on the subset of the identified object (e.g., mouth 306 of news anchor 302, head 308 of news anchor 304). The determined region may be a point, line, area, plane, volume, or any geometric entity, or any combination thereof corresponding to the identified subset. For example, the identified subset is the mouth 306 of news anchor 302 and the AV application determines a virtual region consisting of the area of the mouth 306 positioned at a non-linearly mapped depth (e.g., 1 foot) from the screen. In another example, the AV application determines a virtual region consisting of the volume corresponding to the head 308 of news anchor 304 positioned at a non-linearly mapped depth (e.g., 1 foot) from the screen.

In some embodiments, the AV application defines and causes the transmitting of an audio wave field corresponding to the virtual region in 3D space that is based on the subset of the identified object (e.g., mouth 306 of news anchor 302, head 308 of news anchor 304). The AV application may select one or more piezoelectric transducer elements of the piezoelectric transducer array 314 that are the nearest neighbors to the virtual region that is based on the subset of the identified object. For example, the AV application may only cause the transmitting of the audio wave field corresponding to audio component 310 using the piezoelectric transducer element that is closest to the virtual region determined based on the mouth 306 of news anchor 302. In some examples, the AV application maps individual piezoelectric transducer elements to an area on the screen. For example, the AV application may select a piezoelectric transducer element (e.g., in row 3 column 5) of the piezoelectric transducer array 314 to correspond to a rectangle on the screen's display area, e.g., a rectangle with a first corner at (300 pixels, 100 pixels) and a second corner at (350 pixels, 150 pixels).

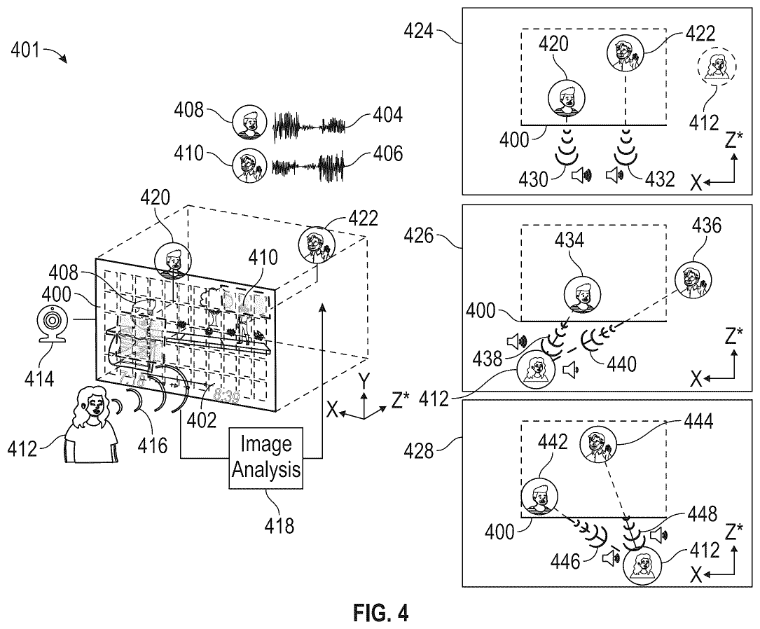

FIG. 4 is a schematic example 401 of determining a virtual region of an identified object in 3D space based at least in part on a determined position of a user, in accordance with embodiments of the disclosure. FIG. 4, in some embodiments, is implemented by system 101 of FIG. 1.

In some embodiments, the AV system identifies that a user 412 is in a proximity of the screen 400 of the client device. The AV system determines a position of the user 412 in relation to the screen of the client device and determines the virtual region (e.g., virtual region 420 or 422) of the identified object (e.g., identified object 408 or 410) in 3D space in relation to the screen 400 of the client device based at least in part on the determined position of the user 412. For example, the AV system conducts image analysis 418 of the visual asset presented on screen 400 of the client device and identifies object 408 corresponding to audio component 404 and object 410 corresponding to audio component 406. The AV application may identify a virtual region 420 and virtual region 422 that are not specifically based at least in part on the position of the user 412, as shown in scenario 424. However, when the AV system identifies that the user 412 is in a proximity of the screen 400 of the client device, the AV application may determine new virtual regions (e.g., new virtual region 434, 442 and new virtual region 436, 444) that are based at least in part on the position of the user 412 of the client device, as shown in scenario 426 and scenario 428.

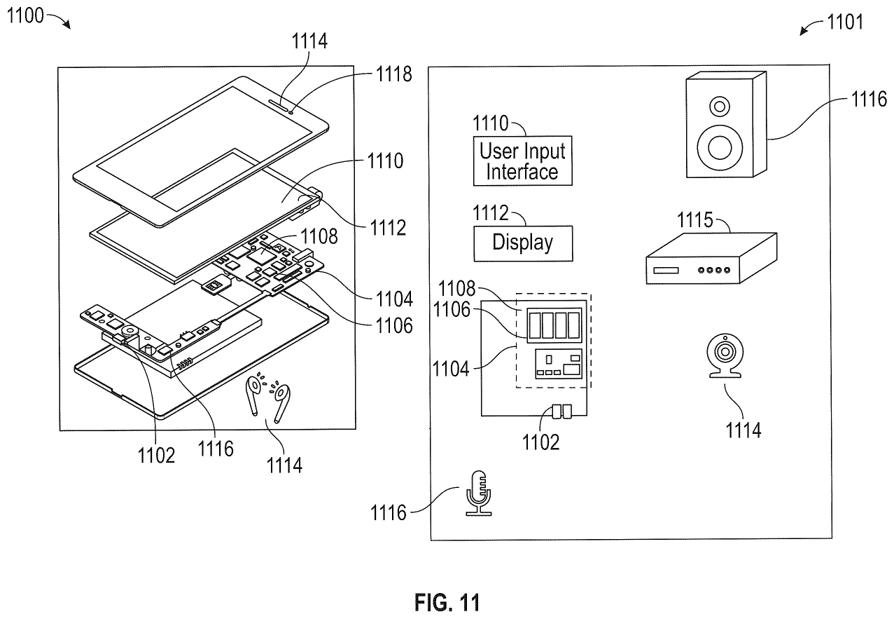

In some embodiments, the AV system includes an image capture device 414 (e.g., image capture device 1118 of FIG. 11) that identifies that a user 412 is in the proximity of the screen 400. In one example, the AV application identifies that the user 412 is in the proximity of the screen 400 by conducting image analysis 418 on the image capture data to identify that the user 412 is within the field of view of the image capture device 414. For example, the image analysis 418 includes object detection and tracking techniques (e.g., as described in FIG. 2). The AV application may additionally identify that the user 412 is in the proximity of the screen 400 by determining that the user 412 is within a threshold distance of the screen 400 based on the image analysis 418. For example, the image analysis 418 includes monocular depth estimation techniques (e.g., as described in FIG. 2) that identify the distance of the user 412 from the screen 400.

In other embodiments, the AV system identifies that a user 412 is in the proximity of the screen 400 by receiving, through the piezoelectric transducer array 402, one or more audio waves 416 that are identified to be emitted by the user 412. The AV application may receive the one or more audio waves 416 by controlling the piezoelectric transducer array 402 such that one or more piezoelectric transducer elements of the piezoelectric transducer array 402 function as receivers. In one example, the AV application controls the piezoelectric transducer array 402 such that all piezoelectric transducer elements of the piezoelectric transducer array 402 function as receivers during a calibration mode, wherein the AV application does not cause the piezoelectric transducer array 402 to transmit any audio waves. In this example, the AV application may periodically determine the position of the user 412 during predetermined periods of time or at a period of time determined based on a user interface input received from the user 412.

In another example, the AV application controls the piezoelectric transducer array 402 such that a subset of the piezoelectric transducer elements of the piezoelectric transducer array 402 continuously function as receivers, wherein the AV application does not cause the subset of piezoelectric transducers to transmit any audio waves. In this example, the AV application periodically determines the position of the user 412 while simultaneously causing the transmitting of one or more audio waves to the user 412. The AV application may also dynamically select piezoelectric transducer elements of the piezoelectric transducer array 402 to allocate to the subset of piezoelectric transducer elements functioning as receivers, wherein the subset of piezoelectric transducer elements may comprise distinct piezoelectric transducer elements at each time point in the content item.

The selection of the subset of piezoelectric transducer elements functioning as receivers may be based at least in part on the selection of piezoelectric transducer elements of the piezoelectric transducer array 402 functioning as transmitters, e.g., the subset of the plurality of piezoelectric transducer elements that are selected by the AV application to transmit an audio wave associated with an audio wave profile, as shown in 1404 and 1410 in FIG. 14. For example, the piezoelectric transducer array may comprise 48 piezoelectric transducer elements labeled 0 through 47, arranged in a 4×12 rectangular configuration (e.g., a top row of 12 elements is labeled 0-11 from left to right, a first middle row of 12 elements is labeled 12-23 from left to right, a second middle row of 12 elements is labeled 24-36 from left to right, and a bottom row of 12 elements is labeled 37-48 from left to right). The AV application selects a first subset (e.g., piezoelectric transducer elements 0 through 5) to transmit the first audio wave field and selects a second subset (e.g., piezoelectric transducer elements 14-18) to transmit the second audio wave profile. The AV application additionally selects a subset functioning as transmitters (e.g., one or more piezoelectric transducer elements that are between 6 and 13).

In some embodiments, the AV application determines a position of the user 412 based on one or more audio waves 416 that are received through the piezoelectric transducer array 402. In one example, the AV application first isolates the one or more audio waves 416 that correspond to the user 412 using voice recognition analysis. Based at least in part on the signal that is received by each of the subset of piezoelectric transducer elements functioning as a receiver, the AV application determines the position of the user 412 that is producing the one or more audio waves 416. The AV application may use properties of the incoming audio waves 416 (e.g., time of arrival, angle of arrival, delay estimation) in addition to localization techniques (e.g., triangulation, estimation algorithms) to determine the position of the user 412. The AV application may identify that the user 412 is within a proximity of the screen 400 based on the position of the user 412 being within a threshold distance of the screen 400.

In some embodiments, the AV application may identify multiple users within a proximity to the screen 400. For example, the AV application identifies a first user 412 that is in a proximity to the screen 400 and subsequently identifies a second user that is in the proximity to the screen 400. In one example, the AV application determines an average position between the two users, e.g., equidistant between the two users, and determines the virtual region based on the average position. In another example, the AV application determines the virtual region based on the position of either the first user 412 or the second user or may alternatively determine a virtual region that is not based at least in part on any position of any user. The AV application may determine a virtual region that is based on a default position of the first or second user (e.g., 2 feet in front of the center of the screen 400, at the last known location of the first or second user). The default position may be based on a user interface selection and/or a user profile associated with the first or second user.

In other embodiments, the AV application fails to identify a user 412 in the proximity of the screen 400, as shown in scenario 424. For example, the AV application identifies object 408 corresponding to audio component 404 and object 410 corresponding to audio component 406. The AV application does not identify a user 412 in the proximity of the screen 400 of the device (e.g., the user 412 may be behind the plane of the screen 400 and cannot be detected by image capture device 414). In one example, the AV application determines a virtual region 420 and virtual region 422 to be located at their corresponding identified 2D positions in the plane of the content item, shifted in a direction orthogonal to the plane of the video asset by a magnitude corresponding to the identified depth. The AV application then defines and causes the transmitting of audio wave field 430 and audio wave field 432, wherein the audio wave field 432 may have a greater average amplitude and perceived volume than audio wave field 430 at certain positions in 3D space due to the virtual region 422 being positioned further behind the screen 400 than virtual region 420. In another example, the AV application may determine a virtual region corresponding to each audio component based on a default position of the user (e.g., 2 feet in front of the center of the screen 400, the last identified position of the user 412). The default position may be based on a user interface selection and/or a user profile associated with the user 412.

In some embodiments, the AV application identifies a position of the user 412 and determines a virtual region (e.g., virtual region 434, virtual region 436) based on the identified position. As shown in scenario 426, the user 412 may be positioned on the left side of the screen 400. In one example, the AV application determines a virtual region 434 and virtual region 436 to be located at their corresponding identified 2D positions in the plane of the video asset. The AV application determines a direction to shift each virtual region based on the position of the user 412 as well as the 2D position of the object in the plane of the video asset. The AV application then shifts the virtual region in the determined direction by a magnitude corresponding to the identified depth, e.g., resulting in shifted virtual region 434 and shifted virtual region 436. The AV application may then define and cause the transmitting of audio wave field 438 and audio wave field 440 based at least in part on the shifted virtual region 434 and shifted virtual region 438, respectively. In the representative example depicted in scenario 426, the AV application causes transmitting of audio wave profiles such that the user 412 perceives the audio source corresponding to object 434 to be closer to the user 412 than the audio source corresponding to the object 436 (e.g., audio wave field 438 has greater average amplitude and perceived volume than audio wave field 440 at the position of the user 412).

As shown in scenario 428, the user 412 may be positioned on the right side of the screen 400. In another example, the AV application determines a virtual region 442 and virtual region 444 to be located at their corresponding identified 2D positions in the plane of the video asset. The AV application then shifts the virtual region in the determined direction by a magnitude corresponding to the identified depth, e.g., resulting in shifted virtual region 442 and shifted virtual region 444. The AV application may then define and cause the transmitting of audio wave field 446 and audio wave field 448 based at least in part on the shifted virtual region 442 and shifted virtual region 444, respectively. In the representative example depicted in scenario 428, the AV application causes transmitting of audio wave profiles such that the user 412 perceives the audio source corresponding to object 442 to be to be the same distance away from the user 412 than the audio source corresponding to the object 444 (e.g., audio wave field 442 has the same average amplitude and perceived volume as audio wave field 444 at the position of the user 412).

FIG. 5 is a schematic example 501 of assigning a default virtual region in 3D space to an additional audio component, which does not correspond to an object depicted on the screen, in accordance with embodiments of the disclosure. FIG. 5, in some embodiments, is implemented by AV system 101 of FIG. 1.

In some embodiments, the AV application identifies an audio component in a time segment of the audio asset but fails to identify an object corresponding to the audio component in the corresponding time segment of the video asset (e.g., or in any time segment of the video asset). For example, as shown in process 500, the AV application identifies an audio component 506 corresponding to a speaker in the time segment of the audio asset 502. In the corresponding time segment of the video asset 504, the AV application identifies an object 510 that corresponds to the speaker, as shown in process 512. In process 500, the AV application also identifies an audio component 508 corresponding to background music 512. However, the AV application fails to identify an object in the time segment of the video asset 504 (e.g., or in any time segment of the video asset) corresponding to background music 512.

In some embodiments, the AV application determines a default virtual region in 3D space for an audio component that does not correspond to an object in the corresponding time segment of the video asset (e.g., or in any time segment of the video asset), as depicted in process 514. For example, the AV application determines a predetermined default virtual region 518 (e.g., a plane positioned at a greater depth than virtual region 516 corresponding to audio component 506) that is assigned to all audio components that do not correspond to an object in the corresponding time segment of the video asset (e.g., or in any time segment of the video asset).

In other embodiments, the AV application causes the transmitting of an audio component (e.g., audio component 508 corresponding to background music 512) that does not correspond to an object in the corresponding time segment of the video asset or any time segment of the video asset through traditional audio delivery methods (e.g., mono speakers, stereo speakers). The AV application may also cause the transmitting of such an audio component through one or more channels of the piezoelectric transducer array, wherein causing the transmitting is not based at least in part on an audio wave profile. In some embodiments, the AV application causes the transmitting of such a corresponding audio wave field that is not based on a determined virtual region.

In some embodiments, the AV application identifies an audio component (e.g., a monologue from a speaker who has yet to appear on the screen) in a time segment of the audio asset and an object corresponding to the audio component in a different time segment of the video asset. For example, the AV application identifies an object 510 corresponding to audio component 506 in a time segment of the video asset 504. However, the AV application may identify the audio component 506 in a time segment prior to time segment of the audio asset 502 and may not be able to identify the object 510 in the corresponding time segment of the video asset before the time segment of the video asset 504. The AV application determines a default virtual region in the prior segment based on image analysis of the time segment of the video asset 504 (e.g., searching ahead through the video asset to find a corresponding object).

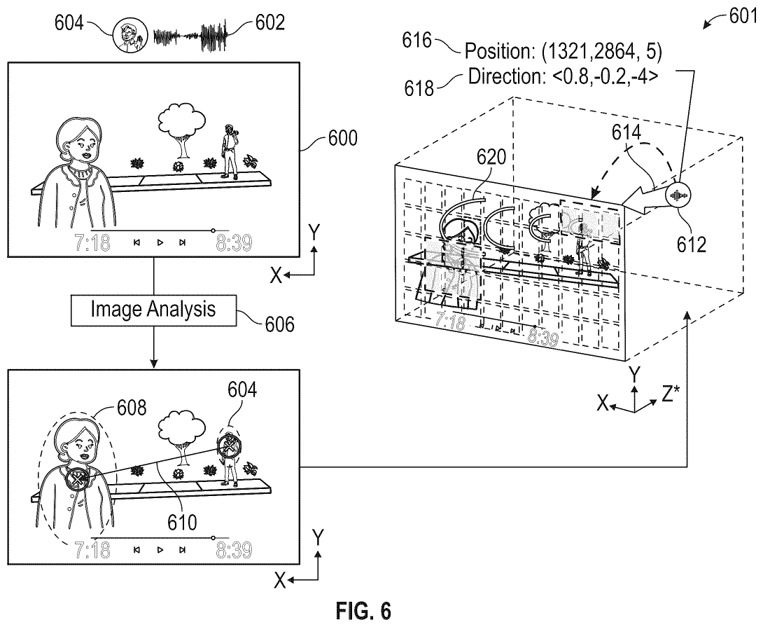

In another example, the AV application dynamically stores the determined virtual regions such that the default virtual region is determined based on the last determined position of the corresponding object in the visual asset. For example, an audio component for a speaker exiting from frame-left would be delivered to the user such that the user perceives the speaker as if they were at their last seen position within the video asset. The AV application may additionally interpolate previously stored virtual regions to dynamically shift the virtual region based on its last observed motion within the video asset. The AV application may search through previous frames of the video asset to find a corresponding object and determines the default virtual region based on image analysis of a prior time segment (e.g., search backwards through the video asset to find a corresponding object) FIG. 6 is a schematic example 601 of causing the transmitting of an audio wave field based on a vector that represents a direction of an audio component, in accordance with embodiments of the disclosure. FIG. 6, in some embodiments, is implemented by AV system 101 of FIG. 1.

In some embodiments, the AV application additionally determines, based on image analysis 606, a vector 610 that represents a direction of the audio component 602. In one example, the AV application identifies, based on the image analysis 606, an object 604 (e.g., a person 604 shouting across a street to a friend 608) corresponding to an audio component 602 within a time segment of the video asset 600. The AV application also identifies, based on the image analysis 606, an additional object 608 (e.g., the friend 608 being shouted at). The AV application then determines a virtual region for each of the objects based on the image analysis 606 and determines a vector 610 based on the two virtual regions (e.g., originating in the virtual region corresponding to the person 604 and terminating in the virtual region corresponding to the person 608). The AV application may alternatively determine the vector 610 based on the difference between the identified depths and 2D positions of both objects.

In some embodiments, the AV application determines a virtual region (e.g., virtual region 612) based on the vector 610 (e.g., virtual region 614 includes a position 616 and a direction 618). The AV application defines and causes the transmitting of an audio wave field 620 corresponding to the virtual region 612 including direction 614. For example, the AV application defines an audio wave field 620, based on an approximation of the wave propagation of the audio component originating from a directional source at the virtual region 612, wherein audio is emitted in the direction 614. In some examples, the AV application determines a virtual region that additionally includes a beamwidth (e.g., horizontal beamwidth, vertical beamwidth). The beamwidth may be a certain number of degrees, or other unit of measurement, away from the vector, wherein the audio wave field outside of the beamwidth is partially or fully attenuated.

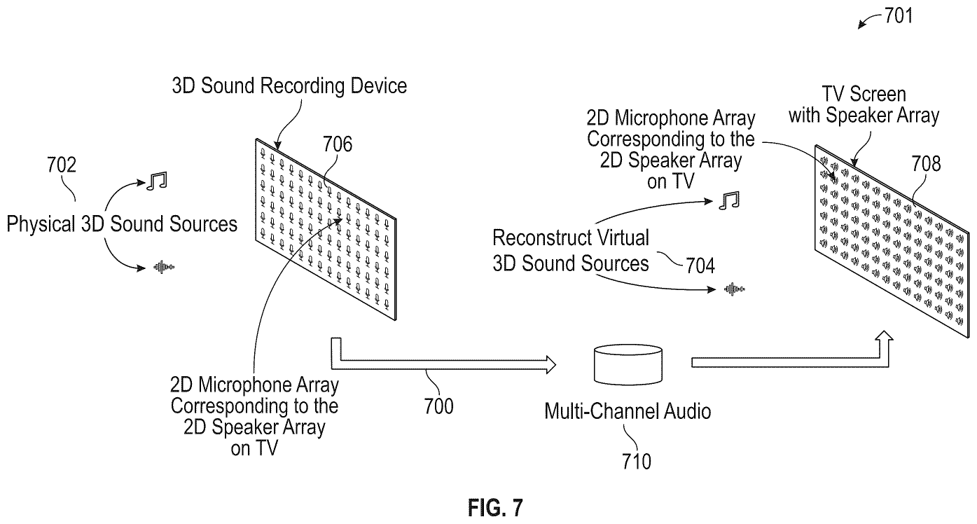

FIG. 7 is a schematic example 701 of direct recording and playback of three-dimensional audio with a piezoelectric transducer array, in accordance with embodiments of the disclosure.

In some embodiments, the AV system comprises a piezoelectric transducer array 706 configured to record multi-channel audio 710. As shown in process 700, the piezoelectric transducer array 706 receives one or more audio waves from one or more audio sources 702. The piezoelectric transducer array 706 stores the one or more audio waves as multi-channel audio 710, e.g., wherein the audio wave received at each piezoelectric element is stored in a single corresponding channel. The multi-channel audio 710 is then transmitted by a piezoelectric transducer array 708 configured to transmit audio. In one example, the piezoelectric transducer array 706 that records the multi-channel audio 710 is the same array that transmits the multi-channel audio 710. In this example, the multi-channel audio 710 may be stored locally on the AV system or on a server (e.g., server 1004 of FIG. 10) and the receiving elements can map directly onto the transmitting elements, limiting the need for additional audio processing.

In other embodiments, the transmitting piezoelectric transducer array 708 includes a different configuration of piezoelectric transducer elements from the receiving piezoelectric transducer array 706. In such embodiments, the AV application reconstructs the audio sources 704, e.g., by identifying audio components within the multi-channel audio using audio analysis (e.g., blind source separation techniques, model-based separation techniques, time-frequency analyses) and determining a position of each audio source 702 based on localization techniques (e.g., triangulation, estimation algorithms). In one example, the AV application determines a virtual region for each identified audio source and define an audio wave field based on the virtual region. The AV application then causes the transmitting array 708 to transmit the defined audio wave field for each identified audio source. Alternatively, the AV system may map one or more channels of the multi-channel audio 710 to one or more piezoelectric transducer elements of the transmitting piezoelectric transducer array 708, by separating and mixing audio components.

FIG. 8 is an illustrative example 801 of an array of piezoelectric transducers 800 arranged parallel to a screen 802 of the device, in accordance with embodiments of the disclosure.

In some embodiments, the AV system includes a piezoelectric transducer array 800 consists of a planar array of piezoelectric transducer elements (e.g., 2×2 planar array), wherein the plane of the planar piezoelectric transducer array is arranged parallel to the plane of the screen 802. In one example, the plane of the planar piezoelectric transducer array 800 is arranged underneath the screen (e.g., the plane of the planar piezoelectric transducer array 800 is located further from the user than the plane of the screen 802). In another example, the plane of the planar piezoelectric transducer array 800 is coincident with the plane of the screen (e.g., the piezoelectric transducers are embedded within the screen 802). In another example, the plane of the planar piezoelectric transducer array 800 is arranged on top of the screen (i.e., the plane of the planar piezoelectric transducer array 800 is located closer from the user than the plane of the screen 802).

In some embodiments, the piezoelectric transducer array 800 may consist of a planar array of piezoelectric transducer elements that are evenly spaced across the display area of the screen 802. For example, the piezoelectric transducers may be arranged in a rectangular pattern of rows and columns. In other embodiments, the piezoelectric transducer array 800 may consist of piezoelectric transducer elements that are arranged in any configuration within a plane. In one example, the piezoelectric transducer elements are arranged in a radial configuration. The piezoelectric transducer elements may be arranged such that all piezoelectric transducer elements are within the display area of the screen 802. In other embodiments, the piezoelectric transducer array 800 may consist of piezoelectric transducer elements are arranged in any configuration on a surface, wherein the surface may be non-planar (e.g., curved). The screen may also include a non-planar surface. It should be understood that all planar features and aspects described herein are examples and may equally be applicable to non-planar surfaces.

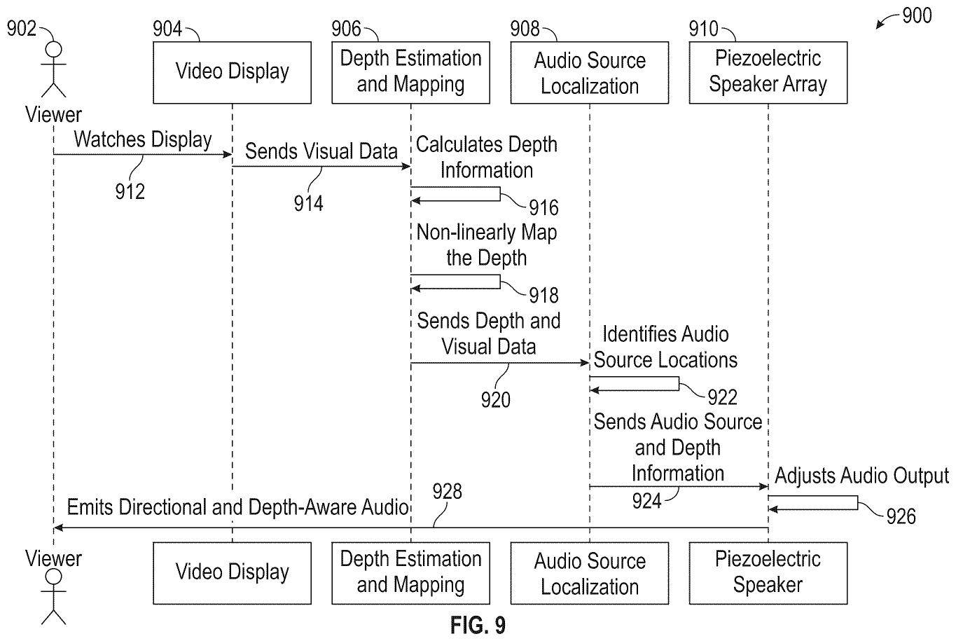

FIG. 9 shows a sequence diagram 900 for causing the transmitting of an audio wave field based on a virtual region for an identified object and an audio component, in accordance with some embodiments of this disclosure. In some embodiments, the AV system may comprise video display 904, depth estimation and mapping 906, audio source localization 908, piezoelectric speaker array 910, and/or any other suitable components, or any suitable combination thereof. At 904, the AV system enables content to be received at a video display 904 (e.g., client device 118 of FIG. 1). At 912, the AV system enables the received content to be displayed at the video display 904 enabling user, 902, to view the display, 912. (e.g., user 412 of FIG. 4). In some embodiments, as described in FIG. 4, AV system identifies a position of user by the piezoelectric transducer array (e.g., piezoelectric transducer array functioning as an audio receiver), detecting sound from user and calculating a distance of the user in relation to the video display. The AV system enables the video display 904 to process, in real time, the received content. The AV system enables the video display 904 to extract data (e.g., metadata) about the visual elements in the content. For example, as shown in FIG. 1, the AV system extracts data from the content 118 about the two characters conversing (e.g., the first object 108 and the second object 110). The AV system may determine that the extracted data identifies a first object 108 and a second object 110.

In some embodiments, the AV system uses image analysis (e.g., 124 of FIG. 1) to identify objects within the visual data 914. Any suitable number or types of techniques may be used to perform such visual data analysis, such as, for example: machine learning, computer vision, object recognition, pattern recognition, facial recognition, image processing, image segmentation, edge detection, color pattern recognition, partial linear filtering regression algorithms, and/or neural network pattern recognition, or any other suitable technique, or any combination thereof. In some embodiments, the AV system identifies objects by extracting one or more features for a particular object and comparing the extracted features to those stored locally and/or at a database or server that stores features of objects and corresponding classifications of known objects.

At 914, the AV system may send visual data of the content to be used to calculate depth estimation and scaling 906 of the visual data 914. Depth estimation and scaling 906 may be handled by components of the AV application and/or AV system. At 916, based at least in part on the visual data 914, the AV system may calculate the depth information 916 of objects identified in the visual data 914. The AV system may calculate the depth of the objects of the visual data 914 based on their perceived distance from the user 902. For example, as shown in FIG. 1, the AV system may extract visual data from the content 118 about the two characters conversing (e.g., the first object 108 and the second object 110). The AV system may determine based at least in part on their perceived distance from the user 116 that the extracted visual data identifies the first character to be two feet from the screen and the second character to be fifty feet away from the screen.

At 918, the AV system may non-linearly scale the depth of the identified objects. For example, following the previous example, based at least in part on the AV system determining the first character to be two feet from the screen and the second character to be fifty feet away from the screen, the AV system non-linearly scales the distance of the first character to be one foot away and the second character to be ten feet away. Non-linearly scaling the depth information of the visual elements enables the preservation of the audibility of audio components (e.g., dialogue), while also providing a three-dimensional audio experience. For example, the AV system may use a function to map the depth from the range [0, infinity] to a range [D1, D2], where D1 is the minimum depth (e.g., zero) while D2 is the maximum depth. Any suitable number or types of techniques may be used to perform such scaling functions to perform this nonlinear scaling, including an exponential decay function (e.g., f(x)=1−e^{-x}), where [0, infinity] is scaled to [0,1], and f(x)=D1+(D2−D1)*(1−e^{-x}) , where [0, infinity] is scaled to [D1, D2]).

At 920, the depth information (e.g., 916 and 918) and the visual data 914 may be used as input to identify audio source localization 908. The AV system may enable audio source localization 908 to use depth information (e.g., 916 and 918) and the visual data 914 to identify the positions of the audio source 922 within the content item. For example, the AV system may identify where specific audio is coming from within the content item (e.g., as shown in FIG. 1, the AV system may identify the first character 108 is speaking).

At 922, the AV system may use audio source localization 908 in addition to depth information and visual data 920 to identify a virtual region for the visual elements in 3D space in relation to the plane of the screen of the client device. For example, as depicted in FIG. 1, the AV system may non-linearly scale the distance of the first virtual region 106 and the second virtual region 104 to the plane of the screen in 3D space 128 such that the first virtual region 106 is perceived as being closer in relation to the screen (e.g., louder) than the second virtual region 104 because the first character 108 was determined to be closer than the second character 110 depicted in the content item 126 in relation to the screen of the client device 118.

In some embodiments, the AV system, at 922, uses audio source localization 908 to localize user position 902 in addition to depth information and visual data to identify a virtual region for the identified objects in 3D space in relation to the screen of the client device. For example, as shown in FIG. 4, the AV system identifies a position of the user 902 (e.g., user 412 of FIG. 4) by the piezoelectric transducer array (e.g., piezoelectric transducer array 402 of FIG. 4) functioning as an audio receiver, detecting sound from user 902, and calculating a distance of the user 1102 in relation to the video display 904 (e.g., client device 400 of FIG. 4). In another example, the AV system may determine a distance of the user 902 in relation to the video display 904 by an image capture device (e.g., image capture device 414 of FIG. 4). For example, as shown in 426 of FIG. 4, the AV system determines, based on the piezoelectric transducers functioning as an audio receiver, that user 412 is located to the left of the visual display and may use this information to identify a virtual region (e.g., virtual region 434) for the identified objects in 3D space in relation to the screen of the client device to enable a directionality of the audio to emulate the audio coming directly from the audio source based on the user's position with respect to the display. In some embodiments, at 924, the AV system provides the audio source and depth information to piezoelectric speaker array 910, which processes the audio source and depth information to determine a corresponding audio output. In other embodiments, the AV system processes the audio source and depth information to define an audio wave field that is provided to piezoelectric speaker array 910.

In some embodiments, the AV system causes piezoelectric speaker array 910 to adjust audio output 926. The AV system may cause piezoelectric speaker array 910 to emit directional and depth aware audio 928 to user 902.

FIGS. 10-11 show illustrative devices, systems, servers, and related hardware for generating a multi-layer image, in accordance with some embodiments of this disclosure. FIG. 10 is a diagram of an illustrative system 1000, in accordance with some embodiments of this disclosure. Computing devices 1007, 1008, 1010 (which may correspond to, e.g., computing device 1100 or 1101 of FIG. 11) may be coupled to communication network 1009. Computer devices 1007, 1008, 1010 may additionally comprise a piezoelectric transducer array. Communication network 1009 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1009) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 10 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 302-11x, etc.), or other short-range communication via wired or wireless paths. The computing devices may also communicate with each other directly through an indirect path via communication network 1009.

System 1000 may comprise media content source 1002, one or more servers 1004, and/or one or more edge computing devices. In some embodiments, system or application may be executed at one or more of control circuitry 1011 of server 1004 (and/or control circuitry of computing devices 1007, 1008, 1010 and/or control circuitry of one or more edge computing devices). In some embodiments, the media content source and/or server 1004 may be configured to host or otherwise facilitate video communication sessions between computing devices 1007, 1008, 1010 and/or any other suitable computing devices, and/or host or otherwise be in communication (e.g., over network 1009) with one or more social network services.

In some embodiments, server 1004 may include control circuitry 1011 and storage 1014 (e.g., RAM, ROM, Hard Disk, Removable Disk, etc.). Storage 1014 may store one or more databases. Storage 1014 may store in a non-transitory memory, instructions for the AV application. Server 1004 may also include an input/output path 1012. I/O path 1012 may include or correspond to input circuitry and/or output circuitry. I/O path 1012 may be used to send and receive commands, requests, and other suitable data. I/O path 1012 may provide content (e.g., content items), machine learning model inputs and/or outputs, device information, or other data, over a local area network (LAN) or wide area network (WAN), and/or other content and data to control circuitry 1011, which may include processing circuitry, and storage 1014. Control circuitry 1011 may be used to send and receive commands, requests, and other suitable data using I/O path 1012, which may comprise I/O circuitry. I/O path 1012 may connect control circuitry 1011 (and specifically control circuitry) to one or more communications paths.

Control circuitry 1011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1011 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1011 executes instructions for an emulation system application stored in memory (e.g., the storage 1014). Memory may be an electronic storage device provided as storage 1014 that is part of control circuitry 1011.

FIG. 11 shows generalized embodiments of illustrative computing devices 1100 and 1101, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 1101 may be a user television equipment system or device.

User television equipment device 1101 may include set-top box 1115. Set-top box 1115 may be communicatively connected to microphone 1116, Audio output equipment (e.g., speaker or headphones 1114), and display 1112. In some embodiments, microphone 1116 may receive audio corresponding to a voice of a user providing input. In some embodiments, display 1112 may be a television display or a computer display. In some embodiments, set-top box 1115 may be communicatively connected to user input interface 1110. In some embodiments, user input interface 1110 may be a remote control device. Set-top box 1115 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 10. In some embodiments, computing device 1100 may comprise any suitable number of sensors (e.g., gyroscope or accelerometer, etc.), and/or a GPS module (e.g., in communication with one or more servers and/or cell towers and/or satellites) to ascertain a position of computing device 1100. In some embodiments, computing device 1100 comprises a rechargeable battery that is configured to provide power to the components of the device.

Each one of computing device 1100 and computing device 1101 may receive content and data via input/output (I/O) path 1102. I/O path 1102 may provide content (e.g., broadcast programming, on-demand programming, Internet content, content available over a local area network (LAN) or wide area network (WAN), and/or other content) and data to control circuitry 1104, which may comprise processing circuitry 1106 and storage 1108. Control circuitry 1104 may be used to send and receive commands, requests, and other suitable data using I/O path 1102, which may comprise I/O circuitry. I/O path 1102 may connect control circuitry 1104 (and specifically processing circuitry 1106) to one or more communications paths (described below). I/O functions may be provided by one or more of these communications paths, but are shown as a single path in FIG. 10 to avoid overcomplicating the drawing. While set-top box 1115 is shown in FIG. 9 for illustration, any suitable computing device having processing circuitry, control circuitry, and storage may be used in accordance with the present disclosure. For example, set-top box 1115 may be replaced by, or complemented by, a personal computer (e.g., a notebook, a laptop, a desktop), a smartphone (e.g., computing device 1100), an XR device; a tablet; a network-based server hosting a user-accessible client device; a non-user-owned device; any other suitable device; or any combination thereof.

Control circuitry 1104 may be based on any suitable control circuitry such as processing circuitry 1106. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1104 executes instructions for the system or application stored in memory (e.g., storage 1108). Specifically, control circuitry 1104 may be instructed by the system or application to perform the functions discussed above and below. In some implementations, processing or actions performed by control circuitry 1104 may be based on instructions received from the system or application.

In client/server-based embodiments, control circuitry 1104 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 1108, and executed by control circuitry 1104 of a computing device 1100.

In some embodiments, the system or application may be a client/server application where only the client application resides on device 1100 (e.g., computing device 102), and a server application resides on an external server (e.g., server 1004). For example, the system or application may be implemented partially as a client application on control circuitry 1104 of device 1100 and partially on server 1004 as a server application running on control circuitry 1011. Server 1004 may be a part of a local area network with one or more of computing devices 1100, 1101 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1004 and/or an edge computing device), referred to as “the cloud.” Device 1100 may be a cloud client that relies on the cloud computing capabilities from server 1004 to determine whether processing should be offloaded from the mobile device, and facilitate such offloading. When executed by control circuitry of server 1004, the system or application may instruct control circuitry 1011 to perform processing tasks for the client device and facilitate the analysis of content items. The client application may instruct control circuitry 1104 to determine whether processing should be offloaded.

Control circuitry 1104 may include communications circuitry suitable for communicating with a server, edge computing systems and devices, a table or database server, or other networks or servers The instructions for carrying out the above-mentioned functionality may be stored on a server (which is described in more detail in connection with FIG. 10. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of computing devices, or communication of computing devices in positions remote from each other (described in more detail below).

Memory may be an electronic storage device provided as storage 1108 that is part of control circuitry 1104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1108 may be used to store various types of content described herein as well as the system or application data described above. Storage 1108 may store in non-transitory memory instructions for AV application. Nonvolatile memory may also be used (e.g., to launch a boot-up routine and other instructions). Cloud-based storage, described in more detail in relation to FIG. 10, may be used to supplement storage 1108 or instead of storage 1108.

Control circuitry 1104 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1104 may also include scaler circuitry for upconverting and downconverting content into the preferred output format of computing device 1100. Control circuitry 1104 may also include digital-to-analog converter circuitry and analog-to-digital converter circuitry for converting between digital and analog signals. The tuning and encoding circuitry may be used by computing device 1100, 1101 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1108 is provided as a separate device from computing device 1100, the tuning encoding circuitry (including multiple tuners) may be associated with storage 1108.

Control circuitry 1104 may receive instruction from a user by way of user input interface 1110. User input interface 1110 may be any suitable user interface, such as a remote control, mouse, trackball, keypad, keyboard, touch screen, touchpad, stylus input, joystick, voice recognition interface, or other user input interfaces. Display 1112 may be provided as a stand-alone device or integrated with other elements of each one of computing device 1100 and computing device 1101. For example, display 1112 may be a touchscreen or touch-sensitive display. In such circumstances, user input interface 1110 may be integrated with or combined with display 1112. In some embodiments, user input interface 1110 includes a remote-control device having one or more microphones, buttons, keypads, any other components configured to receive user input or combinations thereof. For example, user input interface 1110 may include a handheld remote-control device having an alphanumeric keypad and option buttons. In a further example, user input interface 1110 may include a handheld remote-control device having a microphone and control circuitry configured to receive and identify voice commands and transmit information to set-top box 1115.

Audio output equipment 1114 may be integrated with or combined with display 1112. Display 1112 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1112. Audio output equipment 1114 may be provided as integrated with other elements of each one of computing device 1100 and computing device 1101 or may be stand-alone units. An audio component of videos and other content displayed on display 1112 may be played through speakers (or headphones) of audio output equipment 1114. In some embodiments, audio may be distributed to a receiver (not shown), which processes and outputs the audio via speakers of audio output equipment 1114. In some embodiments, for example, control circuitry 1104 is configured to provide audio cues to a user, or other audio feedback to a user, using speakers of audio output equipment 1114. There may be a separate microphone 1116 or audio output equipment 1114 may include a microphone configured to receive audio input such as voice commands or speech. For example, a user may speak letters, words, terms, or numbers that are received by the microphone and converted to text by control circuitry 1104. In a further example, a user may voice commands that are received by a microphone and recognized by control circuitry 1104. Camera 1118 may be any suitable video camera integrated with the equipment or externally connected. Camera 1118 may be a digital camera comprising a charge-coupled device (CCD) and/or a complementary metal-oxide semiconductor (CMOS) image sensor. Camera 1118 may be an analog camera that converts to digital images via a video card. In some embodiments, audio output is played through a piezoelectric transducer array. In some embodiments, the piezoelectric transducer elements of the piezoelectric array functions as receivers. In some embodiments, camera 1118 is used as an image capture device to identify the position of a user.

The system or application may be implemented using any suitable architecture. For example, it may be a stand-alone application wholly-implemented on each one of computing device 1100 and computing device 1101. In such an approach, instructions of the application may be stored locally (e.g., in storage 1108), and data for use by the application is downloaded on a periodic basis (e.g., from an out-of-band feed, from an Internet resource, or using another suitable approach). Control circuitry 1104 may retrieve instructions of the application from storage 1108 and process the instructions to provide the functionality, and generate any of the displays, discussed herein. Based on the processed instructions, control circuitry 1104 may determine what action to perform when input is received from user input interface 1110. For example, movement of a cursor on a display up/down may be indicated by the processed instructions when user input interface 1110 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1104 may allow a user to provide user profile information or may automatically compile user profile information. For example, control circuitry 1104 may access and monitor network data, video data, audio data, processing data, historical interactions by the user, and/or any other suitable data. Control circuitry 1104 may obtain all or part of other user profiles that are related to a particular user (e.g., via social media networks), and/or obtain information about the user from other sources that control circuitry 1104 may access. As a result, a user can be provided with a unified experience across the user's different devices.

In some embodiments, the system or application is a client/server-based application. Data for use by a thick or thin client implemented on each one of computing device 1100 and computing device 1101 may be retrieved on-demand by issuing requests to a server remote to each one of computing device 1100 and computing device 1101. For example, the remote server may store the instructions for the application in a storage device. The remote server may process the stored instructions using circuitry (e.g., control circuitry 1104) and generate the displays discussed above and below. The client device may receive the displays generated by the remote server and may display the content of the displays locally on computing device 1100. This way, the processing of the instructions is performed remotely by the server while the resulting displays (e.g., that may include text, a keyboard, or other visuals) are provided locally on computing device 1100. Computing device 1100 may receive inputs from the user via input interface 1110 and transmit those inputs to the remote server for processing and generating the corresponding displays. For example, computing device 1100 may transmit a communication to the remote server indicating that an up/down button was selected via input interface 1110. The remote server may process instructions in accordance with that input and generate a display of the application corresponding to the input (e.g., a display that moves a cursor up/down). The generated display is then transmitted to computing device 1100 for presentation to the user.

In some embodiments, the system or application may be downloaded and interpreted or otherwise run by an interpreter or virtual machine (run by control circuitry 1104). In some embodiments, system or application may be encoded in the ETV Binary Interchange Format (EBIF), received by control circuitry 1104 as part of a suitable feed, and interpreted by a user agent running on control circuitry 1104. For example, the system or application may be an EBIF application. In some embodiments, the system or application may be defined by a series of JAVA-based files that are received and run by a local virtual machine or other suitable middleware executed by control circuitry 1104. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

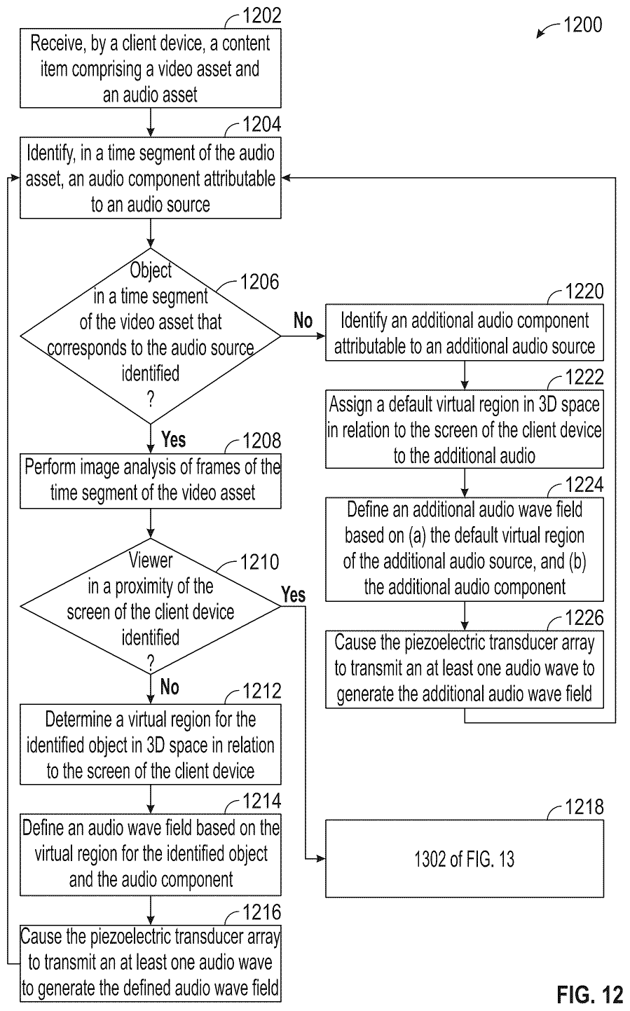

FIG. 12 is a flowchart of a detailed illustrative process for causing a piezoelectric transducer array to transmit at least one audio wave field, in accordance with some embodiments of this disclosure. In various embodiments, the individual steps of process 1200 are implemented by one or more components of the devices, methods, and systems of FIGS. 1-11 and 13-14 and are performed in combination with any of the other processes and aspects described herein. Although the present disclosure may describe certain steps of process 1200 (and of other processes described herein) as being implemented by certain components of the devices, methods, and systems of FIGS. 1-11 and 13-14, this is for purposes of illustration only, and it should be understood that other components of the devices, methods, and systems of FIGS. 1-11 and 13-14 may implement those steps instead.

At 1202, input circuitry (e.g., of I/O path 1012 of FIG. 10 and/or of I/O path 1102 of FIG. 11) may receive, by a client device (e.g., client device 118 of FIG. 1) a content item (e.g., content item 126 of FIG. 1) comprising a video asset and an audio asset. For example, a content item may be received by client device, comprising two characters conversing, and may be provided for display via a screen of client device to a user (e.g., user 116 of FIG. 1).

At 1204, control circuitry (e.g., control circuitry 1011 of FIG. 10 and/or control circuitry 1104 of FIG. 11) may use any suitable computer-implemented technique (e.g., conducting audio analysis with or without prior knowledge of the audio sources, employing one or more of the following techniques: blind source separation techniques, e.g., non-negative matrix factorization or independent component analysis; model-based separation techniques, e.g., deep learning models, neural networks, spectral models; or time-frequency analyses, e.g., short-time Fourier transform, time-frequency masking, or spectrogram analysis) to identify, in a time segment of the audio asset, an audio component attributable to an audio source. For example, control circuitry may identify audio components 112 and 114 of FIG. 1 correspond to audio sources in the time segment of the audio asset.

At 1206, the control circuitry may determine whether an object is depicted in a time segment of the video asset of the content item that corresponds to the identified audio source. For example, the control circuitry may determine that the identified audio components (e.g., audio components 112 and 114 of FIG. 1) attributable to audio sources correspond to objects (e.g., characters 108 and 110 of FIG. 1 conversing) depicted in a time segment of the video asset. In some embodiments, the control circuitry determines whether an object is depicted in a time segment of the video asset that corresponds to the identified audio source by referencing metadata associated with the content item. In other embodiments, the control circuitry is configured to employ any suitable computer implemented technique (e.g., one or more machine learning models) to perform image analysis (e.g., image analysis 124 of FIG. 1) of a video asset (e.g., video asset 126 of FIG. 1) to identify one or more objects corresponding to an audio component attributable to an audio source.

If an object depicted in the time segment of the video asset of the content that corresponds to the identified audio source is identified, the process proceeds to 1208. At 1208, the control circuitry may perform image analysis of frames of the time segment of the video asset. For example, in the corresponding time segment of the video asset, control circuitry may identify objects (e.g., characters 108 and 110 of FIG. 1) that corresponds to audio components (e.g., audio components 112 and 114 of FIG. 1).

If no object depicted in the time segment of the video asset of the content item that corresponds to the audio source is identified, the process may proceed to 1220. In some embodiments, an additional audio component attributable to an additional audio source may be identified. For example, a content item may comprise a video asset (e.g., video asset 504 of FIG. 5) and an audio asset (e.g., audio asset 502 of FIG. 5). The control circuitry may determine that an audio component (e.g., audio 508 corresponding to background music 512) does not correspond to an object depicted in a time segment of the video asset (e.g., control circuitry may determine that there are no objects depicting background music 512 in the time segment of the video asset 504 of FIG. 5).

At 1222, control circuitry may assign a default virtual region in 3D space in relation to the screen of the client device to the additional audio. For example, control circuitry may assign a predetermined default virtual region in 3D space (e.g., virtual region 518 of FIG. 5) that is assigned to all audio that does not correspond to an object in the corresponding time segment of the video asset (e.g., or in any time segment of the video asset).

At 1224, control circuitry may define an additional audio wave field based on (a) the default virtual region of the additional audio source, and (b) the additional audio component. For example, as depicted in FIG. 5, control circuitry may define an audio wave field based at least in part on the default virtual region of the additional audio source 518 and the additional audio component 508 (e.g., corresponding to the background music 512) that does not correspond to an object in the corresponding time segment of the video asset or any time segment of the video asset.

At 1226, control circuitry may cause the piezoelectric transducer array arranged parallel to the screen to transmit at least one audio wave to generate the audio wave field. For example, control circuitry causes the transmitting of an audio component (e.g., audio component 508 corresponding to background music 512 of FIG. 5) that does not correspond to an object in the corresponding time segment of the video asset or any time segment of the video asset through traditional audio delivery methods (e.g., mono speakers, stereo speakers). Control circuitry may also cause the transmitting of such an audio component through one or more channels of the piezoelectric transducer array, wherein the causing the transmitting is not based at least in part on an audio wave profile. In some embodiments, control circuitry causes the transmitting of such a corresponding audio wave field that is not based on a determined virtual region. After 1226, the process returns to 1204.

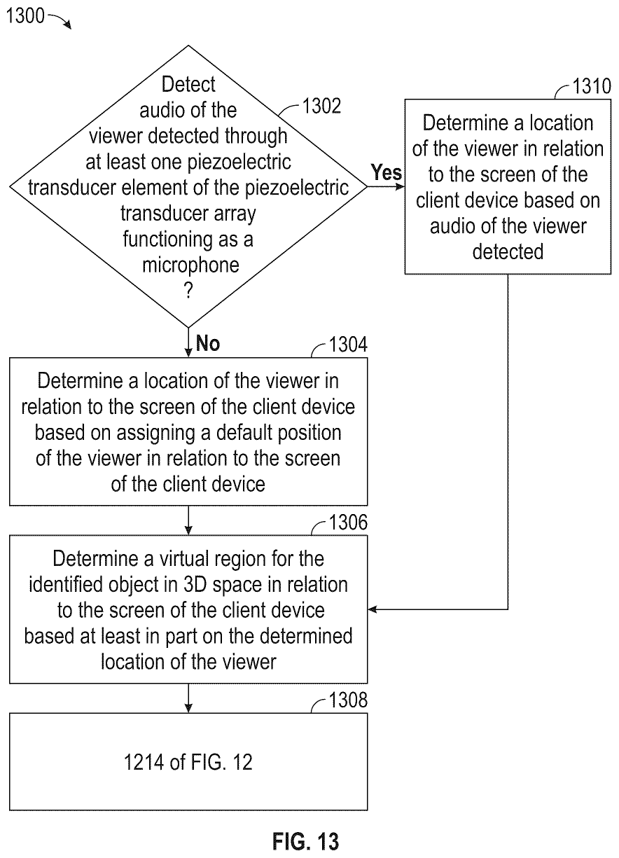

At 1210, the control circuitry may determine whether a user is identified in a proximity of the screen of the client device. If a user is identified in the proximity of the screen of the client device, the process continues to 1302 of FIG. 13. For example, as shown in FIG. 4, the control circuitry (e.g., and the input circuitry) may identify a position of a user (e.g., user 412 of FIG. 4) by detecting audio of a user (e.g., audio wave 416 of user 412 of FIG. 4) through a piezoelectric transducer array (e.g., piezoelectric transducer array 402 of FIG. 4), where one or more piezoelectric transducer elements are functioning as an audio receiver, and calculating a distance of the user in relation to the screen of the client device (e.g., screen 400 of FIG. 1). In another example, the control circuitry may determine a distance of the user in relation to the display based on the input circuitry receiving an image from an image capture device. If no user is identified in the proximity of the screen of the client device, the process proceeds to 1212.

At 1212, control circuitry may determine a virtual region for the identified object in 3D space in relation to the screen of the client device. For example, as depicted in FIG. 1, control circuitry may, using image analysis 124, determine that the first object 108 is displayed as closer to the screen of client device 118 and the second object 110 is at a distance away from the first object 108 (e.g., the second object 110 is determined to be 10 ft away from the first object 108) as depicted in the video asset of content item 126. Based at least in part on the image analysis 124, control circuitry determines a first virtual region 106 for the first identified object 108 in 3D space 128 and a second virtual region 104 for the second identified object 104 in 3D space 128. For example, control circuitry may non-linearly scale the depth of the first virtual region 106 (i.e., the distance of the first virtual region 106 from the screen) and the depth of the second virtual region 104 in 3D space 128. The control circuitry may determine the virtual regions such that a user perceives the first virtual region 106 as being closer in relation to the screen (e.g., louder) than the second virtual region 104.

At 1214, control circuitry may define an audio wave field based on the virtual region for the identified object and the audio component. For example, control circuitry defines an audio wave field (e.g., audio wave field 100 and 102 of FIG. 1), wherein some audio wave fields may have a greater average amplitude (e.g., and perceived volume) than other audio wave fields at certain positions in 3D space due to the positioning of the virtual regions. In one example, the control circuitry defines an audio wave field based on an approximation of the wave propagation of the audio component originating from a point source at a point in the virtual region (e.g., the centroid of the virtual region). In this example, the audio wave field is comprised of concentric spherical wavefronts of constant phase centered around the source. In another example, the control circuitry defines an audio wave field based on an approximation of the wave propagation of the audio component originating from a distributed source spread over the virtual region. The control circuitry may also define an audio wave field (e.g., audio wave field 100 or 102 of FIG. 1) based on an approximation of the wave propagation of the audio component originating from a directional source, wherein audio is emitted at higher amplitudes in certain directions. In these embodiments, the control circuitry models the effects of attenuation (e.g., a decrease in amplitude with distance consistent with the inverse square law) and optionally the effects of environmental factors (e.g., identified objects in the visual asset that reflect, refract, or absorb audio waves and consequently affect audio wave propagation behavior).

At 1216, control circuitry (e.g., using I/O path), may cause the piezoelectric transducer array arranged parallel to the screen to transmit an at least one audio wave to generate the defined audio wave field. For example, control circuitry may cause the generation of the audio wave fields (e.g., audio wave field 100 and field 102 of FIG. 1) by decomposing the audio wave field into multiple audio waves and causing each piezoelectric transducer element of the piezoelectric transducer array to generate an audio wave such that the interference pattern of the audio waves generates the desired audio wave field (e.g., via the Huygens Fresnel principle). Control circuitry may send multi-channel audio to the piezoelectric transducer array (e.g., piezoelectric transducer array 120 of FIG. 1) in order to precisely control the audio waves generated by each piezoelectric transducer element.

FIG. 13 is a flowchart of a detailed illustrative process for determining a virtual region of an identified object in 3D space based at least in part on a determined position of a user, in accordance with some embodiments of this disclosure. In various embodiments, the individual steps of process 1300 may be implemented by one or more components of the devices, methods, and systems of FIGS. 1-12 and 14 and may be performed in combination with any of the other processes and aspects described herein. Although the present disclosure may describe certain steps of process 1300 (and of other processes described herein) as being implemented by certain components of the devices, methods, and systems of FIGS. 1-12 and 14, this is for purposes of illustration only, and it should be understood that other components of the devices, methods, and systems of FIGS. 1-12 and 14 may implement those steps instead.

At 1302 control circuitry (e.g., control circuitry of 1011 of FIG. 10 and/or control circuitry 1104 of FIG. 11) may determine whether audio of a user (e.g., user 412 of FIG. 4) is detected through at least one piezoelectric transducer element of piezoelectric transducer array functioning as an audio receiver. If at 1302, control circuitry detects a user through the piezoelectric transducer array, the process proceeds to 1310. At 1310, control circuitry may determine a position of the user in relation to the screen of the client device based on the detected audio of the user. For example, control circuitry identifies a user (e.g., user 412 of FIG. 4) in the proximity of a screen (e.g., screen 400 of FIG. 4) by receiving, through the piezoelectric transducer array (e.g., piezoelectric transducer array 402 of FIG. 4) one or more audio waves (e.g., audio wave 416 of FIG. 4) that are identified to be emitted from a user (e.g., user 412 of FIG. 4). Control circuitry may receive the one or more audio waves (e.g., audio wave 416 of FIG. 4) by controlling the piezoelectric transducer array such that one or more piezoelectric transducer elements of the piezoelectric transducer array function as audio receivers.

If at 1302, control circuitry does not detect a user through the piezoelectric transducer array, the process proceeds to 1304. At 1304, control circuitry may determine a position of the user in relation to the screen of the client device based on assigning a default position of the user at the center of the screen of the client device. For example, if the control circuitry is unable to identify a user in the proximity of the screen of the device (e.g., audio of user 412 of FIG. 4 cannot be detected by client device 400), control circuitry determines a default position of the user at the center of the screen of the client device.

At 1306, control circuitry may determine a location of the viewer in relation to the screen of the client device based on assigning a default position of the viewer in 3D space in relation to the screen of the device. For example, 424 of FIG. 4 depicts a position of a user 412 undetectable in relation to the screen of the client device. In scenario 424 of FIG. 4, virtual region 420 and virtual region 422 of FIG. 4 are determined for identified objects (e.g., characters 408 and 410) in 3D space in relation to the screen of the client device to be located at their corresponding identified 2D positions in the plane of the content item, shifted in a direction orthogonal to the plane of the video asset by a magnitude corresponding to the identified depth based on the assigned default position of the user (e.g., located at the center of the screen of the client device). The default position may consist of any position in 3D space in relation to the screen of the device (e.g., 2 feet in front of the center of the screen of the device).

In another example, at 1306, the control circuitry determines a virtual region for an identified object in 3D space in relation to the screen of the client device based at least in part on the determined position of the user in relation to the screen of the client device, where the determined position of the user may be based on detected audio of the user or an assigned default position. For example, as depicted in scenario 426 of FIG. 4, the user 412 may be positioned on the left side of the screen 400. The control circuitry determines a virtual region 434 and virtual region 436 to be located at their corresponding identified 2D positions in the plane of the video asset. The control circuitry may determine a direction to shift each virtual region based on the position of the user 412 as well as the 2D position of the object in the plane of the video asset. Control circuitry may shift the virtual region in the determined direction by a magnitude corresponding to the identified depth, e.g., resulting in shifted virtual region 434 and shifted virtual region 436.

At 1308 , control circuitry may proceed to 1214 of FIG. 12, defining an audio wave field based on the virtual region for the identified object and the audio component. For example, following the representative example depicted in scenario 426 of FIG. 4, control circuitry may cause the transmitting of audio wave profiles such that user 412 perceives the audio source corresponding to object 434 to be closer to the user 412 than the audio source corresponding to the object 436 (e.g., audio wave field 438 has greater average amplitude and perceived volume than audio wave field 440 at the position of the user 412).

FIG. 14 is a flowchart of a detailed illustrative process for causing a piezoelectric transducer array to generate an audio wave field associated with an additional audio component, in accordance with some embodiments of this disclosure. In various embodiments, the individual steps of process 1400 are implemented by one or more components of the devices, methods, and systems of FIGS. 1-13 and are performed in combination with any of the other processes and aspects described herein. Although the present disclosure may describe certain steps of process 1400 (and of other processes described herein) as being implemented by certain components of the devices, methods, and systems of FIGS. 1-13, this is for purposes of illustration only, and it should be understood that other components of the devices, methods, and systems of FIGS. 1-13 may implement those steps instead.

At 1402, the control circuitry (e.g., control circuitry of 1011 of FIG. 10 and/or control circuitry 1104 of FIG. 11) may identify, in a time segment of the audio asset, an additional audio component attributable to an additional audio source. For example, control circuitry may identify, based on the image analysis (e.g., image analysis 124 of FIG. 1), a first object (e.g., a first character 108 of FIG. 1). The control circuitry may also identify, e.g., based on the image analysis (e.g., image analysis 124 of FIG. 1), an additional object (e.g., a second character 110 of FIG. 1) corresponding to an audio component (e.g., audio component 114 corresponding to the second character 110 of FIG. 1) within a time segment of the video asset of a content item.

At 1404, control circuitry may select, based on the virtual region, a first subset of the plurality of piezoelectric transducer elements of the piezoelectric transducer array to transmit the at least one audio wave to generate the audio wave field. For example, as depicted in FIG. 1, control circuitry may select a first subset of the plurality of piezoelectric transducer elements 122 of the piezoelectric transducer array 120 to transmit the at least one audio wave to generate the audio wave field 100.

At 1406, control circuitry may cause the transmitting of the at least one audio wave to generate the audio wave field using only the first subset of the plurality of piezoelectric transducer elements. For example, as depicted in FIG. 1, the audio wave associated with the audio wave field 100 is transmitted using only the first subset of the plurality of piezoelectric transducer elements 122.

At 1408, control circuitry may define an additional audio wave field based on: (a) an additional virtual region of an additional identified object in 3D space that corresponds to the additional audio source, and (b) the additional audio component. For example, control circuitry determines a virtual region (e.g., virtual region 104 of FIG. 1) corresponding to the identified 2D positions in the plane of the content item, shifted in a direction orthogonal to the plane of the video asset by a magnitude corresponding to the identified depth and the additional audio component (e.g., additional audio component 114 of FIG. 1). Based on the (a) an additional virtual region of an additional identified object in 3D space that corresponds to the additional audio source, and (b) the additional audio component an additional audio wave field is defined (e.g., an additional audio wave field 102 of FIG. 1).

At 1410, control circuitry may select, based on the additional virtual region, a second subset of the plurality of piezoelectric transducer elements of the piezoelectric transducer array to transmit the at least one audio wave to generate the additional audio wave field. In some embodiments, the first subset and the second subset do not comprise a common piezoelectric transducer element. For example, as depicted in FIG. 1, a second subset of the plurality of piezoelectric transducer elements 124 of the piezoelectric transducer array 120 are selected to transmit the at least one audio wave associated with the additional audio wave field 102, wherein the first subset 122 and the second subset 124 do not comprise a common piezoelectric transducer element, such that each piezoelectric transducer element transmits audio waves for only one audio wave field at a time. In other embodiments, the first subset and the second subset comprise one or more common piezoelectric transducer elements, where the control circuitry causes the common piezoelectric transducer elements to transmit mixed audio to generate both the audio wave field and the additional audio wave field.

At 1412, control circuitry may cause the transmitting of the at least one audio wave to generate the additional audio wave field using only the second subset of the plurality of piezoelectric transducer elements. For example, as depicted by FIG. 1, control circuitry may transmit the at least one audio wave to generate the additional audio wave field (e.g., additional audio wave field 102 of FIG. 1) using only the second subset of the plurality of piezoelectric transducer elements (e.g., the second subset of the plurality of piezoelectric transducer elements 124 of FIG. 1).

1. A method comprising:
receiving by a client device a content item comprising a video asset and an audio asset, wherein the client device comprises a screen and a piezoelectric transducer array comprising a plurality of piezoelectric transducer elements arranged parallel to the screen;
identifying, in a time segment of the audio asset, an audio component attributable to an audio source;
identifying an object depicted in a time segment of the video asset of the content item that corresponds to the audio source;
performing image analysis of frames of the time segment of the video asset;
determining, based at least in part on the image analysis, a virtual region for the identified object in 3D space in relation to the screen of the client device;
defining an audio wave field based on the virtual region for the identified object and the audio component attributable to the audio source; and
causing the piezoelectric transducer array to transmit an at least one audio wave to generate the defined audio wave field.

2. The method of claim 1, wherein the determining the virtual region for the identified object in 3D space of the identified object in relation to the screen of the client device comprises:
determining, in a frame of the video asset, a 2D position in a plane of the screen, and a depth of the identified object from the plane of the screen; and
determining, based on the identified 2D position and the identified depth, the virtual region of the identified object in 3D space in relation to the screen of the client device, wherein a distance of the virtual region from the screen of the client device is based on non-linearly scaling the identified depth.

3. The method of claim 1, wherein the determining, based at least in part on the image analysis, the virtual region of the identified object in 3D space in relation to the screen of the client device further comprises:
identifying, based at least in part on the image analysis, a subset of the identified object wherein the audio component attributable to the audio source originates from the subset of the identified object; and
determining the virtual region of the identified object in 3D space based on the subset of the identified object.

4. The method of claim 3, wherein the identified object is a person, and the subset of the identified object is a mouth of the person.

5. The method of claim 1, wherein causing the piezoelectric transducer array to transmit the at least one audio to generate the defined audio wave field further comprises:
selecting, based on the virtual region, a subset of the plurality of piezoelectric transducer elements of the piezoelectric transducer array to transmit the at least one audio wave; and
causing the transmitting of the at least one audio wave using only the subset of the plurality of piezoelectric transducer elements.

6. The method of claim 1, further comprising:
identifying, in the time segment of the audio asset, an additional audio component attributable to an additional audio source;
defining an additional audio wave field based on: (a) an additional virtual region of an additional identified object in 3D space that corresponds to the additional audio source; and (b) the additional audio component; and
causing the piezoelectric transducer array arranged parallel to the screen to transmit an additional at least one audio wave to generate the defined additional audio wave field.

7. The method of claim 6, further comprising:
selecting, based on the virtual region, a first subset of the plurality of piezoelectric transducer elements of the piezoelectric transducer array to transmit the at least one audio wave to generate the defined audio wave field;
causing the transmitting of the at least one audio wave to generate the defined audio wave field using only the first subset of the plurality of piezoelectric transducer elements;
selecting, based on the additional virtual region, a second subset of the plurality of piezoelectric transducer elements of the piezoelectric transducer array to transmit the at least one audio wave to generate the defined additional audio wave field, wherein the first subset and the second subset do not comprise a common piezoelectric transducer element; and
causing the transmitting of the at least one audio wave to generate the defined additional audio wave field using only the second subset of the plurality of piezoelectric transducer elements.

8. The method of claim 1, further comprising:
identifying a user is in a proximity of the screen of the client device; and
determining a position of the user in relation to the screen of the client device, wherein the determining the virtual region of the identified object in 3D space in relation to the screen of the client device is further based at least in part on the determined position of the user.

9. The method of claim 8, wherein the determining the position of the user in relation to the screen of the client device is based on audio of the user detected through at least one piezoelectric transducer element of the piezoelectric transducer array functioning as a microphone.

10. The method of claim 1, further comprising:
identifying, in the time segment of the audio asset, an additional audio component attributable to an additional audio source, wherein the additional audio source does not correspond to an object depicted in the time segment of the video asset of the content item;
assigning a default virtual region in 3D space in relation to the screen of the client device to the additional audio source;
defining an additional audio wave field based on (a) the default virtual region of the additional audio source, and (b) the additional audio component; and
causing the piezoelectric transducer array to transmit an additional at least one audio wave to generate the defined additional audio wave field.

11. The method of claim 1, wherein the defining the audio wave field based on the virtual region for the identified object and the audio component attributable to the audio source comprises:
determining, based on the image analysis, a vector that represents a direction of the audio component; and
defining the audio wave field based on the vector and the virtual region of the identified object.

12. The method of claim 11, further comprising:
identifying an additional object depicted in the time segment of the video asset of the content item, wherein the determined vector originates in the object and points in the direction of the additional object.

13. The method of claim 1, wherein the plurality of piezoelectric transducer elements is further arranged underneath the screen of the client device and within a display area of the screen of the client device.

14. The method of claim 1, wherein the time segment of the audio asset and the time segment of the video asset comprise a same period of time.

15. A system comprising:
input/output circuitry configured to:
receive by a client device a content item comprising a video asset and an audio asset, wherein the client device comprises a screen and a piezoelectric transducer array comprising a plurality of piezoelectric transducer elements arranged parallel to the screen;
control circuitry configured to:
identify, in a time segment of the audio asset, an audio component attributable to an audio source;
identify an object depicted in a time segment of the video asset of the content item that corresponds to the audio source;
perform image analysis of frames of the time segment of the video asset;
determine, based at least in part on the image analysis, a virtual region for the identified object in 3D space in relation to the screen of the client device;
define an audio wave field based on the virtual region for the identified object and the audio component attributable to the audio source; and
cause the piezoelectric transducer array to transmit an at least one audio wave to generate the defined audio wave field.

16. The system of claim 15, wherein the control circuitry is configured to determine the virtual region for the identified object in 3D space of the identified object in relation to the screen of the client device is further configure to:
determine, in a frame of the video asset, a 2D position in a plane of the screen, and a depth of the identified object from the plane of the screen; and
determine, based on the identified 2D position and the identified depth, the virtual region of the identified object in 3D space in relation to the screen of the client device, wherein a distance of the virtual region from the screen of the client device is based on non-linearly scaling the identified depth.

17. The system of claim 15, wherein the control circuitry is configured to determine, based at least in part on the image analysis, the virtual region of the identified object in 3D space in relation to the screen of the client device is further configured to:
identify, based at least in part on the image analysis, a subset of the identified object wherein the audio component attributable to the audio source originates from the subset of the identified object; and
determine the virtual region of the identified object in 3D space based on the subset of the identified object.

18. (canceled)

19. The system of claim 15, wherein the control circuitry is configured to cause the piezoelectric transducer array to transmit the at least one audio to generate the defined audio wave field is further configured to:
select, based on the virtual region, a subset of the plurality of piezoelectric transducer elements of the piezoelectric transducer array to transmit the at least one audio wave; and
cause the transmitting of the at least one audio wave using only the subset of the plurality of piezoelectric transducer elements.

20-21. (canceled)

22. The system of claim 15, wherein the control circuitry is further configured to:
identify a user is in a proximity of the screen of the client device; and
determine a position of the user in relation to the screen of the client device, wherein the determining the virtual region of the identified object in 3D space in relation to the screen of the client device is further based at least in part on the determined position of the user.

23-26. (canceled)

27. The system of claim 15, wherein the plurality of piezoelectric transducer elements is further arranged underneath the screen of the client device and within a display area of the screen of the client device.

28-70. (canceled)
